(19) United States
(12) Patent Application Publication
(10) Pub. No.: US 2005/0007001 A1
(43) Pub. Date: Jan. 13, 2005

(54) Process and apparatus for energy storage and release

(76) Inventors: Timothy James Imholt, Carrollton, TX (US); David Allara, State College, PA (US); Bruce Gnade, Lewisville, TX (US); James Andrew Roberts, Krum, TX (US)

Correspondence Address: Michael G. Cameron,;Jackson Walker LLP., Suite 600, 2435 North Central Expressway, Richardson, TX, 75080, US

(21) Appl. No.: 10/846,045

(22) Filed: May 14, 2004

Related U.S. Application Data
(63) Continuation-in-part of application No. 10/764,092, filed on Jan. 23, 2004.
(60) Provisional application No. 60/442,385, filed on Jan. 24, 2003.

(51) Int. Cl. H01J 17/26

(52) U.S. Cl. 313/231.31

(57) ABSTRACT

The present invention provides a process and apparatus to store and deliver controlled amounts of heat and light energy, from low levels to very intense levels, to microscopic locations in a object remotely, not necessarily involving direct contact with the object, where the energy delivered remotely is less than the energy released by the object. More specifically, the present invention comprises a novel and previously unanticipated source of local energy production by the exposure of carbon nanotubes by EM radiation in the radio and microwave spectral regions. The present invention comprising a process and apparatus to remotely delivering highly controlled amounts of EM to the carbon nanotubes.

### CROSS REFERENCE TO RELATED APPLICATIONS; CLAIM OF PRIORITY

This application is a continuation-in-part of U.S. patent application Ser. No. 10/764,092, Imholt, et al., filed Jan. 23, 2004, which claims priority to U.S. Provisional Patent Application No. 60/442,385, filed on Jan. 24, 2003, entitled “Process and Apparatus for Microwave Desorption of Hydrogen and Other Elements from Carbon Nanotubes”, the entire contents of which are incorporated herein by this reference. The Applicant hereby claim the benefits of this earlier pending regular and provisional application under 35 U.S.C. Section 119(e). This application is also related to United States patent application filed May 12, 2004, entitled “Process and Apparatus for Energy Storage and Release,” Imholt et al., the entire contents of which are incorporated herein by this reference.

### BACKGROUND OF THE INVENTION

Carbon nanotubes, discovered in 1991 by Sumio lijima, are materials consisting of multiple layers of closed carbon shells, with a graphite like chemical structure. The carbon nanotubes which have multiple interior pipes that are layered on one another are termed multi-walled carbon nanotubes (“MWNTs”). The diameters of MWNTs are typically 4-30 nanometers (“nm”) with lengths of up to 1 micrometer, with many layers, at times there being up to 100 layers. These graphite pipes are seamless. More recent discoveries into the nature of carbon nanotubes have led to the production of carbon nanotubes consisting of only one seamless pipe of carbon. These carbon nanotubes are referred to as single-walled carbon nanotubes (“SWNTs”). The diameters of SWNTs range from 0.4-3 nm while the lengths range typically from one or more micrometers to many centimeters. SWNTs are unique in that they exhibit a tensile strength stronger than steel with a density lower than aluminum. They are also thermally stable to very high temperatures when in a non-oxidizing environment with the tube remaining chemically intact up to at least 2000 K and higher. Carbon nanotubes are regarded as the most thermally stable chemical structure known under vacuum conditions. When exposed to air at high temperatures, or at appropriate wavelength/power levels of electromagnetic behavior, carbon nanotubes behave as other carbon materials in that they will ignite and undergo combustion.

The reactions and mechanisms described herein with respect to carbon nanotubes have also been observed in nanostructures of other materials provided such nanostructures are below the critical dimensions for that material. The critical dimension issue changes as the frequency increases in the microwave region. At higher frequencies, a slightly higher diameter can be employed, however smaller diameters still gives a more efficient interaction meaning more thermal release. For purposes of the disclosure, general reference to carbon nantotubes shall also mean nantubes and other similar nanostructures, which can be adapted to provide the effects described herein.

Vacuum systems are operable to continuously remove air and other gasses from a vessel. In certain applications of the present invention, oxygen and other reactive gases preferably need to be excluded to deliver controlled local heat. The exclusion of reactive gasses can be accomplished by containment of the carbon nanotubes in an inert atmosphere or by application of a vacuum prior to or during use. The vacuum required, however, is typically just enough to remove a major fraction of atmospheric oxygen from the system and prevent oxidation. Alternatively, objectives of the present invention can be achieved by placing the nanotubes, in an inert atmosphere or by application of a vacuum prior to initiation of the reaction. This can also be achieved by placement of the nanotubes in some polymer material or high explosive or propellant, as further described herein.

The transfer of electric energy in a conducting medium results in generation of radiating low frequency electromagnetic (“EM”) fields with the exact nature of the fields dependent upon the nature of the conductor and the time variation of the electrical conduction. Methods of EM generation vary by the energy carriers which typically consist of electrons in vacuum tubes, wires or semiconductor emission devices. Traditional devices for generation of radiation in the radio and microwave frequency region of the EM spectrum include MASERS, klystrons, backward wave oscillators, magnetrons, and semiconductor emitters. All of these devices can be scaled from very small to very large levels or power output, e.g., such as those found in radar sources. MWNTs themselves reportedly have been used as devices to emit microwaves. These nanotube devices indicate that microwave emitters and amplifiers can be scaled down to nanometer scale.

Microwaves are well known to heat a variety of common materials. The majority of microwave assisted processes make use of volumetric heating, that is heating of the entire volume of material exposed to the radiation in a generally uniform way due to the lack of skin depth problems encountered in lasers. The kinetics of these heating effects are far removed from classical heating of conduction or convection. In the later processes, the object to be heated receives heat energy by contact with a gas, liquid or solid that has a higher temperature than the object to be heated. Heat thus flows from the contact point to the interior of the object over time, with the amount of time depending upon the thermal conductivity of the object. In contrast, heating by EM radiation with an appropriate frequency is typically carried out such that the object receives the radiation uniformly throughout its volume and thus heats uniformly. For objects composed of different materials the materials can be chosen and fashioned together in such a way that one material is heated while there is little effect on the other material. For example, water in a coffee cup can be heated using EM radiation, rather than the coffee cup itself. This is due to the difference in the dielectric property of the coffee cup material versus the water. It is this effect that is in action when microwave safe dishes are used to heat food.

Fabrication and Purification

There are a variety of techniques for fabricating SWNTs. Each of these fabrication techniques causes subtle yet important differences in the resulting nanotubes. These differences include changes in length and diameter, and as a result of these, the aspect ratio (defined as length/diameter). The aspect ratio can change by several orders of magnitude and alter the response of the nanotubes to electromagnetic waves. SWNTs are known to form into “ropes” or bundles.

The first synthesis of carbon nanotubes was a by-product of the arc-discharge method in the fabrication of fullerenes. Their current methods of production are quite varied. These methods include arc-discharge, laser ablation, catalytic hydrocarbon decomposition and carbon monoxide disproportionation to carbon nanotubes plus carbon dioxide (HiPco Process). The MWNTs are made up of 2 to 50 or more concentric graphitic layers and have diameters in the range of 10 to 100 nanometers (“nm”). The SWNT is much thinner with diameters from 0.5 to 1.8 nm.

Multi-Walled Carbon Nanotubes

The current yield of MWNTs formed in the electric arc-discharge method is greater than 50% by weight. MWNTs have high chemical stability and very high mechanical strength. The MWNTs, while not having as many applications as the SWNTs, have been available longer and their synthesis is far less expensive than SWNTs.

When arc discharge is performed with a gap between the carbon electrodes of about 1 mm, cylindrical deposits will form on the surface of the cathode. The diameter of the cathode should be the same as that of the anode. When the diameter of the anode is 8/mm and the electric current is kept at 80 Ampere with He gas pressure of 300 torr, the cathode deposit grows at 2-3/mm per minute. The outer shell of the deposit consists partially of SWNTs with rates up to 30% by weight with the remainder of the material being large clumps of carbon attached to the SWNTs in some way, which must be removed by purification.

The laser ablation method is similar to that first used when C₆₀ was originally discovered. When this method is used for the fabrication of MWNTs, the nanotubes are much shorter than those prepared by the arc discharge method. This method has, therefore, not been utilized for large-scale commercialization of these structures. The advantage of this method is the very high yields, reaching as high as 40% by weight of MWNTs and SWNTs.

The catalytic decomposition of hydrocarbons is a primary fabrication method of MWNTs. The MWNTs produced by this method are much more pure than those obtained by the other methods with yields as high as 50% by weight of the deposits being MWNTs. The higher yields in turn require less purification, thus decreasing the cost of fabrication, as the majority of the material removed in the fabrication process is bulk carbon material. Critical aspects of production are length, diameter, and alignment, all of which can be controlled with this method of fabrication.

Single-Walled Carbon Nanotubes

The structure of SWNTs is essentially rolled up graphite forming a very small, thin cylinder with no seam. The length and the diameter of these types of nanotubes are dependent on the type of metallic catalyst employed as well as the precise methodology used during fabrication. The maximum-recorded lengths have been in the cm length scale with diameters ranging from 0.5 nm to 3 nm. The structure and characteristics of SWNTs are closer to those of fullerenes than MWNTs. SWNTs are a novel one-dimensional material having many unique physical properties. MWNT properties are more closely approximated to bulk graphite. In general, the fabrication of SWNTs is almost the same as with MWNTs with the addition of a metallic catalyst. The catalysts typically used are Fe, Co, Ne, Cu, and Mg. In some experiments the catalysts have been combined in an effort to increase yields.

Electric arc discharge fabrication of SWNTs results in very low yields. Efforts have been made to increase these yields, but with little success to date. The laser ablation (otherwise known as laser oven) nanotubes produce large yields of nanotubes by utilizing a Co—Ni catalyst. The difficulty in this method is that the amount of amorphous carbon in this apparatus is rather high, making large-scale purification necessary. More recently, it has been shown that SWNTs can be fabricated by hydrocarbon decomposition with an iron catalyst. This fabrication technique allows control of the diameter and length of nanotubes more simply than with previous methods. SWNTs used in one embodiment of the present invention were produced via the HiPco (High Partial Pressure of CO) process. HiPco refers to a process of growing SWNTs using high pressure carbon monoxide in a vapor disproportionation process. In order to be of any practical or commercial use, nanotubes must be produced with high levels of purity in large quantities. The HiPco process has shown some promise of being scaled up for large scale production and can also produce nanotubes that are >90% pure. In this synthesis process, a reaction of Fe(CO)₅ and CO gas at high pressure and high temperature takes place. When the metal catalyst atoms form larger clumps of material, approximately the size of the C₆₀ molecule, they nucleate and form SWNTs. This occurs because a SWNT is a more stable form of carbon than what is in the chamber at this point in the process. Due to this, the carbon will preferentially take on the SWNT form.

Electronic Properties of Single-Walled Nanotubes

The configuration of a carbon nanotubes (hereinafter, assumed to be SWNTs) is fabricated by rolling up a sheet of monolayered graphite. Any configuration can be reached by changing the chiral angle. This angle is defined by the chiral vector R=aX+bY. X and Y are both exactly equal and hold the value (3)^{1/2}D_{c}. D_{c} is the carbon-carbon bond length. If a nanotube is generated by some chiral vector (a,b) it is referred to as nanotube (a,b). This is the convention utilized in the majority of the literature. The fabricated SWNTs will fall into one of three basic forms known as armchair, zigzag or helical. Further, two parameters determine if a nanotube is metallic or semiconducting—the vector (a,b), mentioned above. The type of nanotube can be calculated in the following fashion.

| | | |
|---|---|---|
| Metallic: | 2a + b = 3N | (N is any positive integer) |
| Semiconducting: | 2a + b ≠ 3N | (N is any positive integer) |

By “metallic,” it is meant that there is a zero bandgap in the electronic structure or semi metallic with meVs of bandgap in semiconductor having about 1 meV of bandgap.

Interior Spaces of Carbon Nanotubes

Various mechanisms have been suggested as to how to fill the inner cavity of carbon nanotubes. It has also been suggested that once filled, the properties of carbon nanotubes will undergo great change. The filling of nanotubes by liquids has been achieved experimentally. The efficiency of the filling is related to the liquid surface tension. Studies have revealed a spontaneous capillary effect for different substances. This effect occurs when a material is spontaneously absorbed into the interior of the nanotube, filling the inner void.

Researchers have attempted to place hydrogen inside carbon nanotubes. Much of the hydrogen is stored on the outer surfaces and interstitial areas in the nanotube ropes. This leaves the interior spaces also available for storage of hydrogen. In order to place the hydrogen inside the nanotubes, many different techniques have been attempted, such as high-pressure environments and liquid hydrogen baths. One approach involves channeling hydrogen through the walls of the nanotubes. This channeling and storage can be achieved with kinetic energy levels in the range of 2-20 eV.

Mechanisms of Hydrogen Storage in Carbon Nanotubes

There have been disclosed a number of studies of adsorption of not only hydrogen but other gases on various adsorbent structures. Primary interest has been given to the noble gases near surfaces of carbon nanotube walls. Some of these works are concerned not only with the physical adsorption to surfaces but also with models of gases in pores with hard walls or repulsive interfaces such as those found in carbon nanotubes. The adsorption of hydrogen and nitrogen has been extensively studied at different pressures and temperatures with the ultimate goal of understanding the physical mechanism of adsorption of carbon nanotubes. There has been some level of agreement between numerical simulations for hydrogen adsorption on the surface of carbon nanotubes indicating that the natural tendency of these surfaces is to adsorb the gases rather than absorbing them internal to the capillary spaces. The overall efficiency of adsorption is similar in nature to that of planar graphitic surfaces. What is desired is a means to make use of the pore volume in carbon nanotubes by which its storage capacity could be increased by a factor of ten. By controlling parameters such as nanotube diameters and lengths adsorption capacity can be maximized. These studies of gas adsorption on nanostructures suggest that there is a possibility of adsorbing enough hydrogen on SWNTs for practical commercial application.

The filling of the inner capillary of carbon nanotubes will contribute greatly to their use as fuel cell storage mediums. Presumably, this can be achieved through channeling of the hydrogen atom or molecule into the nanotube. If a beam of hydrogen atoms were incident on the walls of the nanotubes with energy levels of approximately 20 eV, the atoms will rip through the wall and enter the nanotube. The defects in nanotubes on the scale caused by the channeling will self-repair in approximately 1 pico-second.

There continues scientific discussion as to how well hydrogen can be stored in and on and removed from carbon nanotubes. There are reports that hydrogen may be stored at the rate of 5-10% by weight in SWNT bundles when H₂ molecules are physisorbed to the exterior surfaces and the interstitial areas between the nanotubes in the bundles. Current theories concerning where hydrogen is “stored” in a nanotube matrix is tending toward physisorption on the surface.

For some molecules, certain locations can be immediately ruled out as possible storage locations, assuming that the ropes and bundles will not ‘swell’ in physical dimension. For example, the interstitial channel in the nanotube rope is roughly equal to the kinetic diameter of the H₂ molecule, making it unlikely that much gas could be stored in these locations. However, for H₂, as well as other molecules (N₂, O₂, etc.) the internal diameters of the nanotubes are sufficiently large for storage. The more likely locations of stored gas in SWNT bundles is on the external bundles or in a groove formed at the contact point between adjacent tubes on the outside of the bundles. However, despite the natural tendency of hydrogen to be stored externally on the nanotubes, in theory, it may be placed inside the nanotubes by artificial implantation techniques. One of these methods is referred to as the “flip in” method. If the hydrogen atom is incident on the carbon nanotube with an energy of between 1.52 eV and 20.0 eV, the atom will react with the carbon on the exterior of the nanotubes and still have enough remaining energy to be ‘flipped’ to the interior of the nanotube. If less energetic hydrogen atoms are used, they will be repulsed, more energetic and the nanotube walls may be permanently damaged according to one unproven theory. There are still other theoretical methods of creating hydrogen rich nanotubes. These include the use of high-pressure, pure hydrogen environments and hydrogen environments provided during nanotube fabrication.

Microwaves

Microwave radiation is a term used to describe a range of frequencies in the electromagnetic (“EM”) spectrum typically in the range of 300 MHz to 300 GHz. These frequencies can be described in terms of wavelengths according to:
λ=c/f (1)
where:
λ=wavelength
c=the speed of light
f=frequency of electromagnetic radiation
   This region contains a fairly wide range as compared to other portions of the EM spectrum. Due to the range of wavelengths, the region can be further subdivided into decimeter, centimeter, and millimeter waves.

There are a variety of applications which use electromagnetic waves in the microwave region. These applications include cooking, satellite communications, radar systems and cellular phones. Wavelengths in the microwave region have also found uses in a variety of scientific and commercial applications. An interesting area of application for scientific laboratories is in the acceleration of chemical reactions. The application of microwave radiation of various frequencies and power levels greatly accelerate some chemical reactions that would otherwise take many hours, days and even weeks to complete. Efficient removal of hydrogen from nanotubes as well as light emission effects from SWNTs are now shown to be additional applications. If a microwave field is applied to nanotubes, several interesting effects are seen. At certain frequencies such as 2.45 GHz, at certain power levels and at certain distances of the source from the sample, stored hydrogen will be very quickly out-gassed from the sample.

Microwaves, existing at the lower end of the EM spectrum, when considering quantum energies, do not have sufficient energy to cause atoms to go from a ground state to an excited state. They are, in fact, several orders of magnitude away from being able to accomplish this directly. But they are able to couple to the transitions in the hyperfine structure of a dynamical state.

### SUMMARY OF THE INVENTION

The present invention provides a process and apparatus to deliver controlled amounts of heat (thermal) energy, from low levels to very intense levels, to both microscopic and macroscopic locations in a object remotely, not necessarily involving direct contact with the object, where the energy delivered remotely is less than the energy released by the object. This could also be used as a method of converting microwave energy to thermal energy in a very efficient manner. This heat energy released from the carbon nanotubes can be in excess of the amount of energy supplied. The nanotube/microwave reaction also produces a highly ionized plasma, this being a result of much higher E fields in the near field region, which can also be accomplished with the use of resonant conditions in such devices as resonant cavities, and waveguides. This effect can be reduced in physical size to the level of several carbon nanotube ropes (microscopic) to very many nanotubes (macroscopic) effect. This effect is further aided or increased by increasing the purity of the carbon nanotube sample, increasing the density of the nanotube sample, and reducing the diameter of the nanotubes in the sample. More specifically, the present invention comprises a novel and previously unanticipated source of local thermal energy production by the exposure of carbon nanotubes by EM radiation in the radio and microwave spectral regions. The present invention comprising a process and apparatus to remotely delivering highly controlled amounts of EM to the carbon nanotubes.

The EM irradiation of carbon nanotubes releases stored energy in the carbon nanotubes which can act upon local regions of an object in which the carbon nanotubes are distributed. The value of larger E fields delivered by the microwaves in this region causes a release of stored energy in the carbon nanotubes into the local regions of the object in which the carbon nanotubes are located (such as a vacuum system, some other material such as a polymer or explosive material or propellant to induce an explosive reaction) in which the carbon nanotubes are distributed or dispersed. The energy stored in the carbon nanotubes can also be released in large scale in order to act as a type of localized production plant for various forms of energy or power plant.

Elements such as hydrogen, oxygen, argon and nitrogen, or species, are purged from carbon nanotubes when they are heated. A variety of “brute force” techniques can be used to heat carbon nanotubes, but these methods also heat the vessel which is holding the carbon nanotubes, as well as items located thereabout. These techniques can damage the carbon nanotubes in various ways, in many cases, making them non-reusable. Further, conventionally used desorption techniques are very slow in rendering the adsorbed or absorbed gas for use. As such, these techniques are not useful in fuel cell applications. The present invention has the advantage of, among other things, making fuel such as hydrogen or oxygen, or other gases, such as nitrogen or argon, available for use in a fraction of a second to a few seconds, rather than in minutes. The present invention comprises a process of applying a moderately powered microwave field (1.01×10⁻⁵ eV) to SWNTs that contain an alternative fuel such as hydrogen or oxygen or other gas such as nitrogen or argon.

The carbon nanotubes are heated as a result of their interaction with the microwaves. The technology used in generating microwaves is mature, such that microwave generators can be made portable with little difficulty. As used in the present invention, the nanotubes must be in a configuration or space that allows the E-field to be as high as possible. This can be achieved by several different methods such as, but not limited to, near field configurations, or in some resonant device such as a resonant cavity. The nanotubes can be placed in a device such as a heat engine, or a high explosive, or the nanotubes could merely be in empty space, provided in each case that there is no chance for oxidation of the nanotubes. With adequate shielding, portable microwave sources can be made safe for use in vehicles or power generator applications. If a microwave transparent container is used, advantageously, only the carbon nanotubes are heated. Conventionally available microwave transparent containers can be used in the process and apparatus of the present invention. Microwaves, when properly applied to the carbon nanotubes, cause an absorbed or adsorbed gas, such as hydrogen or oxygen, or some other gaseous material, to escape the carbon nanotubes. The released gas can then be used for energy production. The carbon nanotubes useful for this process include SWNTs and multi-wall types. However, the use of carbon nanotubes with smaller aspect ratios is preferable as the hydrogen tends to bond better with highly damaged nanotubes. Undamaged carbon nanotubes also can be used advantageously in the present invention. Moreover, low wattage microwaves, i.e. less than 100 W, can also be used to effectively heat nanotubes, thereby providing a safe level of power input and little to no degradative effect to the tube itself.

### FIGURES OF THE INVENTION

FIG. 1 is a graph illustrating the light emission spectra of carbon nanotube/plasma created by extreme heat.

FIG. 2 is a first photograph of a plasma and light emission from a carbon nanotube sample in a lab with no room lights using a five (5) mg sample of SWNTs.

FIG. 3 is a second photograph of a plasma and light emission from a carbon nanotube sample in a lab with no room lights using a five (5) mg sample of SWNTs.

FIG. 4 is a photograph showing the condition of a quartz vessel after approximately three (3) seconds of microwave irradiation of carbon nanotubes.

FIG. 5 is a diagram of an embodiment of a functional apparatus of the present invention in set-up mode.

FIG. 6 is a diagram of a functional apparatus of the present invention the final state of an operation, showing the use of quartz powder to act as a thermal sink to measure amounts of generated heat.

As seen therein, microwave EM source 502 is seen to irradiate a 40 mg. sample of carbon nanotubes 601 in a 5.0₂ quartz powder 602.

FIG. 7 is a diagram describing the thermal balance calculations of the input microwave energy and the various forms of the output power into the surroundings after approximately 3.3 seconds of irradiation.

FIG. 8 is a schematic illustration of a generalized apparatus or any other implementation which can be configured to utilize the effects of electromagnetic irradiation of carbon nanotubes.

FIG. 9 is a graph showing 5 mg sample of SWNT aborption Spectra.

FIG. 10(a) illustrates SWNTs in an ultra high vacuum tube suspended above the microwave source wherein the tube is shown containing SWNTs under vacuum with room lights on.

FIG. 10(b) illustrates SWNTs under vacuum during microwave irradiation (2.45 GHz, 700 W) with the room lights off;

FIG. 11(a) illustrates the spectrum of light from raw SWNTs when subjected to microwave irradiation;

FIG. 11(b) illustrates the spectrum of light from purified SWNTs when subjected to microwave irradiation.

FIG. 12 is a plot of the spectra of light from both purified and unpurified HiPco Nanotubes as a microwave field is applied;

FIG. 13(a) is a schematic diagram of a two cavity klystron for generating microwaves;

FIG. 13(b) is a schematic diagram of the reflex klyston for generating microwaves;

FIG. 14(a) is the absorption spectrum of bucky paper in the range of 7 to 12 GHz;

FIG. 14(b) is an absorption spectrum of a 5 mg sample of purified SWNTs in the range of 7-12 GHz;

FIG. 14(c) is an absorption spectrum of a 5 mg sample of purified SWNTs in the range of 7-12 GHz of FIG. 14(b), but with an expanded range in the y-axis;

FIG. 15 shows the results of desorption experiments from samples implanted with hydrogen and samples not implanted with hydrogen;

FIG. 16 illustrates the TEM image of the fused carbon nanotubes after microwave irradiation;

FIG. 17 illustrates TEM image showing looped carbon nanotubes after microwave irradiation; and

FIG. 18 is an RGA plot of outgassed materials from carbon nanotubes during microwave application.

### DETAILED DESCRIPTION OF THE INVENTION

The present invention comprises an improved process and apparatus for the irradiation of carbon nanotubes using EM radiation, and the utilization of the effects of the process thereof. The invention is implemented by the deposition or placement of nanotubes at specific locations in or proximate to an object or in isolation. More specifically, the present invention relates to a process and apparatus for delivering controllable amounts of heat energy, from low levels to very intense levels, to microscopic or macroscopic locations in a object remotely, not necessarily involving direct contact with the object, where the energy delivered remotely is less than the energy released from the object or for delivering controllable amounts of heat energy, from low levels to very intense levels generally. The present invention further comprises the process of obtaining a certain reaction and device or method for initiation of said reaction to provide an unexpected source of local thermal energy production by the combination of nanotubes, specifically, but not limited to carbon nanotubes, in the absence of oxygen and in the presence of microwave fields. Specifically, these fields are heavily ‘doped’ to have large E-fields.

Carbon nanotubes are a well known material consisting of microscopic components having among other unique properties certain electromagnetic radiation characteristics in the radio and microwave spectral regions. This exposure of nanotubes to electromagnetic radiation mechanism due to the individual nanotubes scale being on the quantum level to release massive amounts of stored energy. The amounts of energy released from the nanotube matrix is far in excess of the amount of energy supplied while converting it to thermal (heat) energy, compared to the form in which the energy was transported to the nanotubes, EM energy, The nanotubes can subsequently act upon local regions of an object in which the nanotubes are distributed. This stored energy can also be released in a large scale in order to act as a type of energy production plant for various forms of engines for such things but not limited to automobiles or distributed power delivery systems.

EM fields in the microwave range can provide rapid heating for carbon nanotubes. Microwave heating typically makes use of electrical quadropole or dipole resonance radiation absorption mechanisms involving atoms in small groups or as individual molecules. Microwaves can also be used to heat electrically conductive metals that lack these common-heating mechanisms. In these cases, heating occurs by means of microwave interactions with the electrons that are responsible for the conduction of electrical current, although the exact mechanism of action is still being studied. Thus there are several ways that microwave radiation can be used to heat materials. However, for each type of given material, e.g., water, plastics or metals, it is generally true that only some of the mechanisms operate to heat the material. Carbon nanotubes are unique in that microwave induced heating can occur by all of the above listed paths. Because the heating occurs by EM irradiation, it is highly uniform throughout the material exposed to the radiation. Further, since multiple mechanisms are involved, the heating effects can be more efficient than for other materials which are heated via fewer mechanisms, typically only one. Thus, where carbon nanotubes need to be heated efficiently, uniformly and quickly, microwave irradiation is a preferable heating method. Applications include carbon acting in a catalytic system as a catalyst or catalyst support and carbon nanotubes acting as emission sources for charged particles, such as electrons or ions, when placed under electrical bias.

The temperatures to which carbon nanotubes can be heated by microwave irradiation is exceedingly high. Thus microwave heating of carbon nanotubes provides an intense heat source of microscopic size that can be readily placed at the location of interest in variable amounts and volumes from nanometer size to multiple grams. Analysis of the light emitted during microwave irradiation reveals that the temperature within the interior cavity of the carbon nanotubes can increase from room temperature to as high as several thousand degrees in less than one second following exposure to the microwave field. The time required to attain a desired temperature and the level of the temperature are readily controlled by adjusting the microwave power.

When SWNTs are exposed to microwave irradiation in modest vacuum, ˜10⁻³ Torr or lower pressures, any adsorbed or otherwise incorporated hydrogen is readily removed from the matrix within a matter of seconds, the exact time dependent on the power of the irradiated microwaves. During this period and thereafter, the carbon nanotubes continue to absorb the microwave radiation, becoming intensely hot and emit UV, visible and ultraviolet electromagnetic radiation.

The temperature of the carbon nanotubes that have thusly been exposed can be estimated from the well known Wein's law of blackbody radiation:
λ=0.29(K·cm)/T,
where, λ is the wavelength of the peak emission in cm and T is the Temperature in Kelvin. When this equation is applied to a collection of irradiated carbon nanotubes, the temperature is measured to reach approximately 5800K, which is near the surface temperature of the sun.

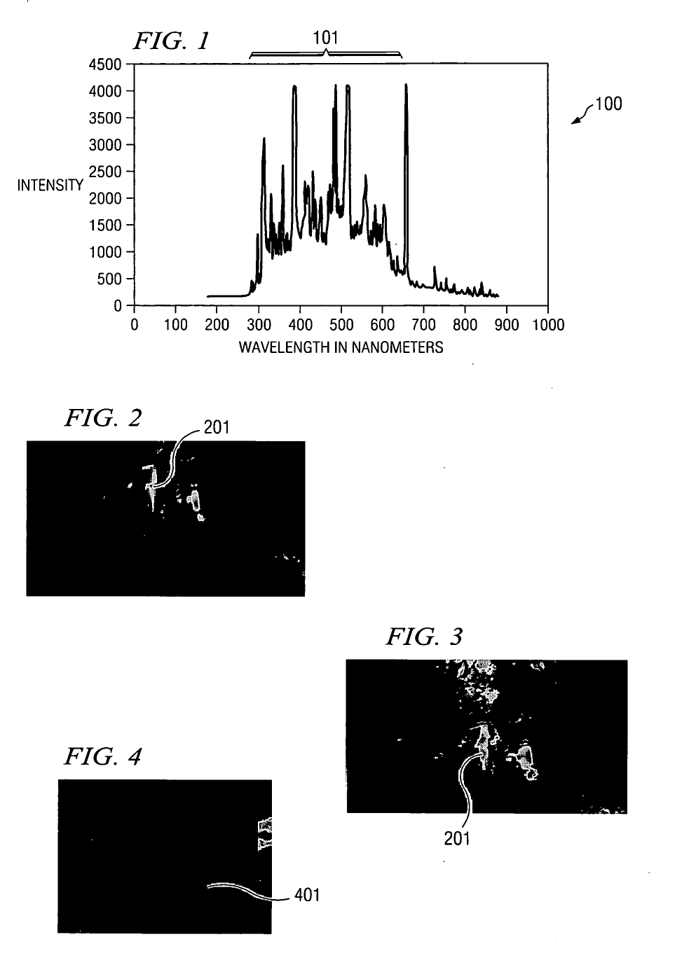

FIG. 1 shows a graph 100 of the spectrum of the light emission from carbon nanotubes that have been exposed to EM radiation in the microwave spectrum. As seen therein, the broad energy portion 101 of the spectrum is caused by the emission from the carbon nanotubes themselves while the spikes are caused by emissions from plasma, which are extremely rapid motions of the electrons and ions of trace atoms inside the nanotubes.

FIGS. 2 and 3 are photographs that demonstrate the total light emission from the carbon nanotube sample 201.

FIG. 4 is a photograph that illustrates the melted condition of the quartz vessel 401 that contained a carbon nanotube sample after approximately three seconds of EM irradiation. The actual heat energy available from the irradiation process is observed to be an unexpectedly extraordinary excess compared to the radiation energy delivered to the system by at least as much energy as supplied to the nanotubes or 1×. The actual number can exceed 1× as some measure of thermal energy released from a reaction in the nanotubes/plasma system. That is, the results of experiments show that more heat becomes available upon irradiation of the SWNT sample than is contained in the microwave EM field that impinges on the sample. This heat imbalance represents a gain in energy during the EM irradiation, similar to when the heat from a match is far outweighed by the heat of burning fuel caused by lighting a fire with the match.

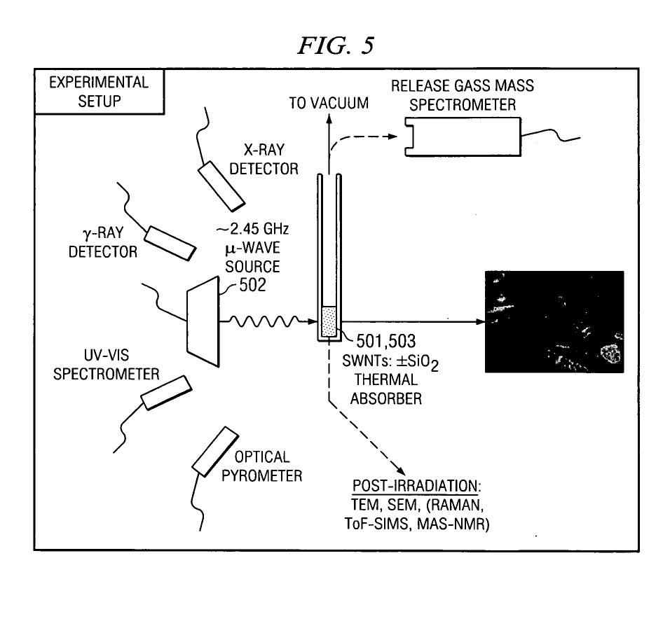

An estimate of the minimum energy output during the process of the present invention was measured by placing a weighed amount of pure quartz powder in a quartz tube containing a weighed amount of SWNTs, sealing the system, applying a vacuum to remove air atmospheric gases to insignificant levels and irradiating the system with microwaves. The results of the experiment and the calculations are shown in the following Figures and tables. FIG. 5 shows the experimental setup and the starting conditions.

FIG. 5 illustrates one embodiment of the present invention, including the setup and the starting conditions. The EM power at the 40×10⁻³ g SWNT sample 501 was estimated from the overall output power of the magnetron source 502 and the geometry of the sample including distance from the source and the sample volume. After approximately 3.3 seconds of exposure to the EM radiation, the sample of quartz, i.e., pure SiO₂ 503 was observed to melt. Since the heat capacity and heat of fusion of quartz is well known, the heat absorbed by the quartz can be readily calculated, as shown in the subsequent Figures and tables. From a calorimetric balance it is seen that (i) the heat delivered by the microwave irradiation to (ii) the heat required to raise the temperature of quartz to the melting point and past this point, is higher than the amount of energy supplied to the sample by the microwave source.

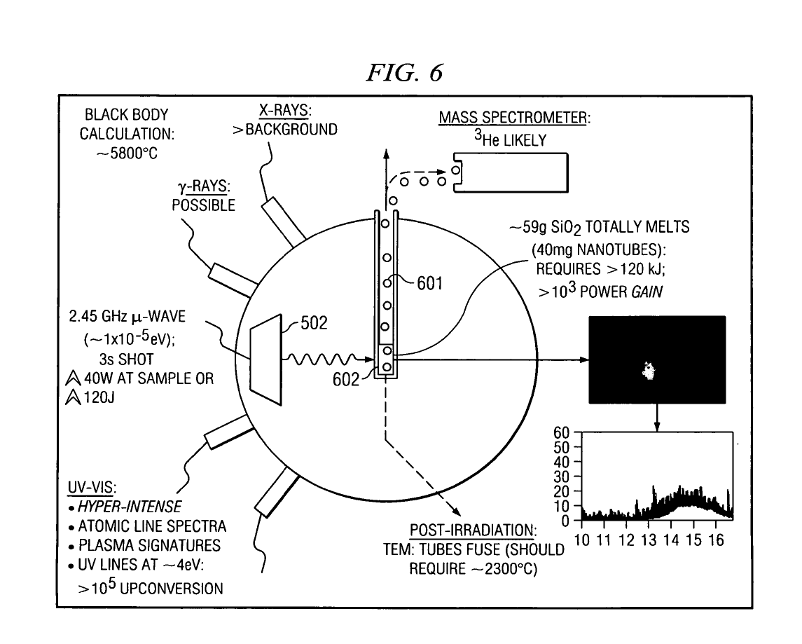

FIG. 6 is a diagram of a functional apparatus of the present invention the final state of an operation, showing the use of quartz powder to act as a thermal sink to measure amounts of generated heat. As seen therein, microwave EM source 502 is seen to irradiate a 40 mg. sample of carbon nanotubes 601 in a SiO₂ quartz powder 602.

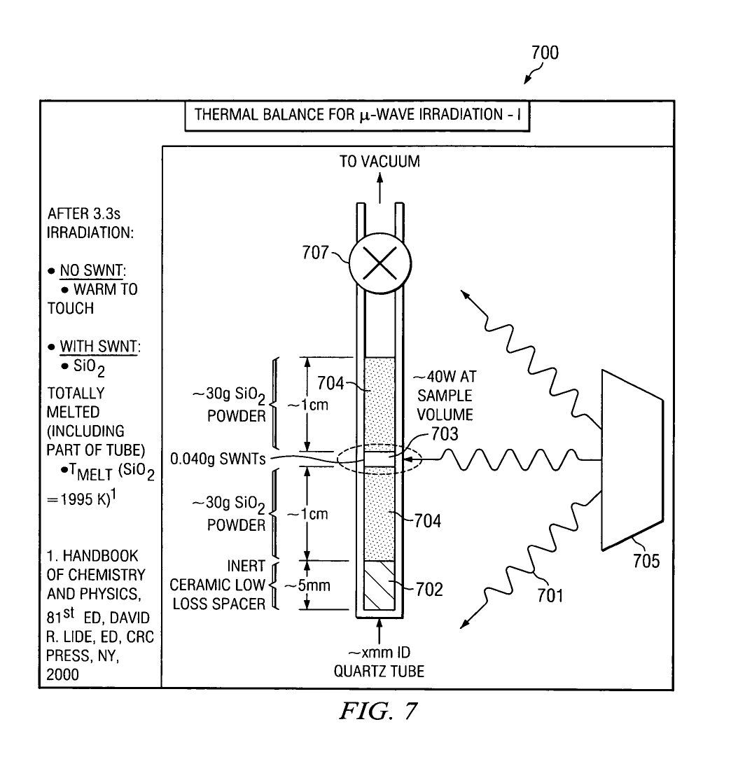

FIG. 7 is a diagram 700 showing the thermal balance calculations of the input microwave energy 701 and the various forms of the output power into the surroundings after approximately 3.3 seconds of irradiation. In principle, according to the first law of thermodynamics the input and output energies must be equal. As seen therein, about 30 grams of SiO₂ powder 701 sits on ceramic low loss spacer 702. On top of SiO₂ powder 701 is placed about 0.040 grams of SWNTs 703. On top of SWNTs 703 is about 30 grams of SiO₂ powder 704. Microwave EM source 705 is between 5 meters and 0.0001 meters from the quartz tube, the closer the microwave source is to the nanotube sample the more effective or efficient this process is due to the higher E-field seen in the near field region. When microwave EM source 705 irradiates this sample under vacuum 707 with about 40 watts of power at 2.45 GHz, the quarts is seen to melt after about 3.3 seconds of irradiation. If SWNTs 703 are removed from the sample, then the SiO₂ 701, 704 does not melt, but is warm to the touch.

Set forth below is a table describing the thermal balance calculations of the input microwave energy and the various forms of the output power into the surroundings after approximately 3.3 seconds of irradiation as seen in FIGS. 6 and 7. As noted above, in principle, according to the first law of thermodynamics, the input and output energies must be equal, unless some form of stored energy is released from the nanotube/microwave system.

Thermal Balance for Microwave Irradiation -II

| | |
|---|---|
| Input: | P at sample volume (˜3cm³) (total power corrected for solid angle): |

˜40W

P absorbed by SWNTs: ˜40W (after ˜0.3 absorption cross section taken

into account)

| | ${\int }_{298}^{1900} {C}_{p} ( t ) ⅆ T = {H°}_{1900} - {H°}_{298}$ |
|---|---|
| Output: | (1^{st} Law of thermo: Q_{OUT} = Q_{IN}) |

Q_{OUT} = Q_{HEAT TUBE} + Q_{MELT Si02} + E_{RADIATION} + Q_{CHEM REACTIONS} + Q_{?}

| | | |
|---|---|---|
| >OJ | >OJ | >OJ |
| | | (only endothermic reactions occur) |

Set forth below is a table describing the heat absorbed to raise the temperature of the quartz to the melting point and the heat required to complete melting.

Thermal Balance for Microwave Irradiation -II

Quartz thermal balance:
Q_{MELT} = Q(heat to mp) + Q(melt)

| | |
|---|---|
| ΔH° (298 →˜1900) | ΔH°_{MELT}(Si0₂, crystal) |

$for 3.3 s irradiation \text{:} {Q}_{IN} ∼ ( 40 \text{J/s} ) ( 3 s ) = 120 J$
= 111.5 kJ/mol (Si0₂, crystal)⁽²⁾
Q_{MELT} = Q(heat to mp) + Q(melt) = 111.5 + 9.6 = 121.1 kJ/mol

2. Data from NIST Standard Reference Database 69, 03/2003 Release: NIST Chemistry WebBook

3. Handbook of Chemistry and Physics, 81^{st} ED, David R. Lide, Ed, CRC Press, NY,

Set forth below is a table describing the thermal balance of the input microwave energy and the minimum output energy as measured by the melting of the quartz and the radiation. The value of the latter quantity is not given but clearly it is positive since intense optical and ultra-violet radiation is observed to come from the sample. The result of the balance is that insufficient energy is inputed from the microwave source to account for all the energy flowing out of the SWNT sample.

### Thermal Balance for Microwave Irradiation—II

Energy Out=heating of surroundings+heat of phase transitions+radiation+energy associated with chemical reactions (+ or −)
Q_{OUT}=Q_{HEAT SYSTEM}+Q_{MELT SiO2}+E_{RADIATION}+Q_{CHEM REACTIONS}=>111.5+9.6 kJ/mol+>0+>0 (endothermic)
Thus, Q_{OUT}>121 kJ/mol
for 60 g of SiO₂ (=1.0 mol): Q_{OUT}>121 kJ
   Conclusion:
Q_{OUT}/Q_{IN}>(121 kJ)/(0.12 kJ)˜10³

Conservative estimate shows power gain [symbol] Additional power source

Set forth below is a table describing the thermal requirements for the reaction of the carbon atoms in the carbon nanotubes with the SiO₂ added. This reaction is known to produce CO₂ and Si at high temperatures. Calculation of the enthalphy and free energy of the reaction from reliable thermo-chemical data from the NIST database shows that the reaction is not spontaneous at the melting point of quartz (˜2000 K) but does proceed at ˜3000 K. However, even at 3000 K, the reaction is endothermic and thus acts as a heat sink, rather than a heat source, such as would occur in combustion. When this is taken account of in the overall thermal balance of the system as seen in the Table immediately above, an additional heat output is required and the ratio of output to input energy becomes even larger than estimated in the table immediately above.

### Chemical Reaction Only Consumes Energy (Energy Sink)

C(SWNT)+SiO₂→CO₂(g)+Si
Calculations from Published Thermochemical Data [NIST Database—Estimate Nanotube as C(graphite)]:
T=298 K: ΔG°₂₉₈=+462 kJ/mol (reaction not spontaneous)
   ΔH°₂₉₈=+517 kJ/mol (endothermic, consumes energy)
T=2000 K: ΔG°₂₀₀₀=+102 kJ/mol (reaction not spontaneous)
   ΔH°₂₀₀₀=+562 kJ/mol (endothermic)
T=3000 K: ΔG°₃₀₀₀=−72 kJ/mol (reaction spontaneous)
   ΔH°₃₀₀₀=+554 kJ/mol (endothermic)
      Conclusion: Reaction spontaneous as T→3000 K, but always consumes energy (˜500 kJ/mol).

Inasmuch as an intense amount of energy is also involved in the EM radiation emitted from the sample and given the delivered heat is required to heat, and partially melt, the quartz tube container, it is evident that the amount of heat output to the area surrounding the carbon nanotubes exceeds the microwave input energy. Therefore, the source of this new energy must come from some form of energy stored within the carbon nanotube that is released when exposed to EM radiation. That is, a carbon nanotube or collections of carbon nanotubes either contains some form of stored energy and/or their unique nanoscale size and geometry provides a material form that allows some new process to take place. In the first case, the carbon nanotube can be viewed as a battery in which there is some form of stored energy that is eventually depleted with continued use. In the second case, the nanotube can be viewed as a catalyst in which its unique structural and chemical character causes some physical process to take place that otherwise would not be observed and which leaves the state of the carbon nanotube unchanged by the occurrence of the process.

A number of experiments using a variety of SWNTs, obtained from different commercial sources and fabricated in different processes, demonstrate the same effects described herein. In addition, the effects are seen, although less dramatically, with MWNTs. Thus, the present invention encompasses all such varieties of such carbon nanotubes, when used under any number of conditions, as the energy release is not due to some specific product but rather is intrinsic to the elementary structure of carbon nanotubes, particularly SWNTs. For example, fairly consistent intense heating is observed with each of the following types of carbon nanotubes:
1. HiPco Nanotubes (average diameter 1.1 nm)
2. Purified HiPco Nanotubes (average diameter 1.1 nm)
3. Laser Oven Nanotubes
4. NEC Nanotube Samples (average diameter from 0.7-1.3 nm)
5. Multi-Walled Nanotubes (not as intense heating)
6. Carbolex Nanotubes (˜1.5 nm in diameter)

The smaller the diameter of the carbon nanotubes, the more efficient the reaction. Applications of the present invention can use any type of carbon nanotube generated in any number of processes. The optimal reactions occur using purified carbon nanotubes, but reactions can occur using raw carbon nanotubes. Reactions occur when the EM radiation which is applied to the carbon nanotubes has a frequency of between 2 GHz to 90 GHz, but optimal reactions occur between 2.4 GHz and 12 GHz. The power of the EM can range from 30 Watts to 100 kilowatts but optimal results occur between 30 Watts and 1 kilowatt. These reactions can occur at any atmospheric pressure, so long as the atmosphere it is substantially free of oxygen, although the presence of oxygen, just results in a hotter reaction.

When carbon nanotubes are placed in an EM field in the microwave and radio wave region, carbon nanotubes can sustain charged particle plasmas that can reach temperatures of at least as high as 5000 Kelvin. Furthermore, these temperatures are attained within a second. These plasmas irradiate intense or hyper bright light that can be as bright as a typical welding arc, generally estimated to be equivalent to a temperature of approximately 6000 Kelvin. The production of hyper bright plasmas from carbon nanotubes exposed to electromagnetic irradiation would allow a method for providing remotely controlled extremely bright light produced instantaneously at the location where the carbon nanotubes are placed. By placing the carbon nanotubes at specific locations (very high E-field points) within the volume of an object that can be penetrated by a remotely controlled EM field, the plasmas will be created at those locations and subsequent irradiation of bright light will bathe and radiate from those regions. Further, by selecting the amount of carbon nanotubes to be placed at a desired location, the intensity of the desired effect can be precisely regulated. By selecting the power of the applied EM field, the intensity of the desired effect can be precisely regulated.

The placement of carbon nanotubes at specific locations followed by controlled irradiation by selected frequencies of electromagnetic fields advantageously allows the delivery of remotely controlled light and heat instantaneously to regions within an object. This feature can be used to initiate chemical reactions or physical processes at that exact location. Since a single carbon nanotube should be able to sustain a plasma, the size or volume of a single location to receive the light from a carbon nanotube will be on the order of the size of the carbon nanotube and thus at the scale of a nanometer in diameter and up to the length of the carbon nanotube.

This novel process of releasing thermal energy, and the apparatus used to implement it, will facilitate numerous improvements of existing applications, such as for use in explosives and propellants, engines and power production plants, and will give rise to novel methods of medical treatments as disclosed herein. The present invention can be used in a variety of applications, including, among other things, engines and medical treatments. All of the applications described herein and those similar thereto are within the scope of the present invention.

Explosive and propellant materials, referred to collectively as explosives, are used widely in both commercial applications, e.g., construction and demolition, and military, and military applications. There continues to be desired more efficient materials and processes for increasing the explosive energy delivered per unit weight while improving the safety of handling and operation of explosives. These efforts have been primarily directed toward making explosive mixtures with smaller particulate sizes of the energetic materials, creating a more uniform distribution of these energetic materials in the binding matrix and finding methods of triggering or detonating the energetic material in as uniform a manner as possible throughout the explosive charge.

The basic principle of an explosive material is the ability to release a large amount of stored energy in a short amount of time in a small space. The explosives described herein typically store energy in a chemical form, as opposed to nuclear explosives where the energetics involve atomic nuclear processes. Typical chemically based explosives require the mixture of at least two materials. A typical mixture consists of a highly oxidizable material, such as powdered aluminum metal, and a strong oxidizing agent which can cause rapid, highly energetic combustion of the oxidizable material along with production of gases from the decomposition of the oxidizing agent. This inherently chemically unstable mixture is prepared in such a way as to be safe to handle but upon application of a trigger, such as an externally applied heat or shock pulse, the material suddenly combusts with an intense emission of heat and the sudden production of a large amount of gas. This combination produces a severe pressure burst which emanates outward as a shock wave, shattering and dispersing materials in its path as well as providing heat energy that can cause thermal degradation and ignition of flammable materials.

The maximum energy release from the explosive is realized when every microscopic volume element across the explosive charge is triggered in unison in the shortest possible time. Application of external detonation, such as a small explosive charge next to the main explosive, inherently causes non-uniform triggering throughout the charge. In particular, detonation at the outside edge of an explosive charge results in delays in propagating the pressure and heat waves into the charge, which in turn cause delays in the chemical reactions in different regions across the sample. If the reactions could be started in all portions of the material simultaneously the efficiency of the explosion would be considerably improved without changing the intrinsic chemical nature of the explosive. For example, one type of ideal detonation would incorporate a triggering material in a highly dispersed form throughout the explosive charge and utilize an externally applied, short pulse excitation that can induce an instantaneous, highly uniform detonation.

This present invention can be adapted to provide such a uniform detonation. The present invention is operable to provide the instantaneous production of localized heating that arises when nanostructures, such as carbon nanotubes, are irradiated with EM waves of microwave frequencies. The present invention has certain advantages over the prior art. First, the nanostructures, such as carbon nanotubes, are extremely small, with diameters at the 1 nm scale and lengths often at the μm scale. Thus these materials, in principle, can be dispersed in an explosive mixture at the scale of the spaces between the particles comprising the mixture to provide an extremely uniform mixture at the nanoscale. Second, it has been shown that the external application of a microwave field near the carbon nanotubes can cause instantaneous, intense heat and light emission. In particular, exposure of a suitably small nanotube (<1.24 nm diameter or less) to a 2.45 GHz microwave heats the nanotubes to a temperature in excess of 2200 degrees Centigrade within 100 ms. While it is well known that microwaves can heat many materials quickly, e.g., boil water in a microwave oven, the heating of nanotubes is orders of magnitude more intense and faster than heating any other material. Thus when a microwave field is properly directed to an explosive charge admixed with highly dispersed carbon nanotubes intense heat and light will be produced in a highly uniform manner across the entire explosive charge at once with detonation events occurring at microscopic distances in unison.

The frequency of electromagnetic radiation is significant in the implementation of this embodiment of the invention. For example, large amounts of concentrated electromagnetic energy of visible or even ultraviolet frequencies could be delivered using laser beams. However, even if such radiation were able to trigger intense energy bursts from carbon nanotubes in an explosive mixture, the fundamental physical principles of the interaction of ultraviolet and visible radiation with materials including those comprising explosive charges limits the effectiveness of detonation. In particular, ultraviolet and visible radiation can usually only penetrate into substance up to ½ of the wavelength of the associated radiation. In the case of visible light the wavelength is in the range of 400 nm. This would imply that the material can only be rapidly heated to a depth of 200 nm. This would not be fast enough for the desired effect in the case of a trigger. For electromagnetic radiation in the microwave region, the wavelength is in the range of 12 centimeters, making it penetrate 6 centimeters into the material. If the microwaves are fired from all sides of the material simultaneously this allows a sufficient amount of the material to be heated for the desire effect.

A further potential advantage of carbon nanotubes in this invention is that not only do the nanotubes heat rapidly but that they appear to heat so rapidly that escaping gas, contained in or around the nanotubes as impurities, will be ejected at such a rate as to induce a local shockwave, which itself provides another triggering mechanism for adjacent explosive material.

Although there are a wide variety of engines, one characteristic of engines remains constant, that is they require some type of release of energy. The present invention comprises a novel process and apparatus for energy release that may be useful in several types of existing engines. The present invention advantageously improves efficiency in engines. The present process and apparatus of this invention is described with reference to several types of engines. Regardless of the fuel used, the fundamental operation of any internal combustion engine is essentially the same, If fuel is introduced to an enclosed space and ignited, energy will be released in the form of an expanding gas. The expanding gas will, in turn, push some type of piston which will drive a series of mechanical devices. These mechanical devices will convert the release of energy into some type of work. In the automobile, the work results in some type of motion for the automobile and its contents.

As described herein, the present invention can be adapted for use as a catalyst for a rapid combustion reaction not entirely dissimilar to current fuel types such as unleaded gasoline or diesel fuel.

Rocket engines, which are reaction based engines, are fundamentally different from internal combustion engines. The operating principal of the rocket engine comes from one of Isaac Newton's fundamental principles of physics which states “For every action there is an equal and opposite reaction.” Essentially a rocket engine directs mass in some direction as a result of some sort of reaction. In most rocket engines, a fuel of some sort is introduced to a reaction chamber. The fuel is ignited and burns. This reaction creates a high-pressure and high velocity stream of gas. This high pressure, high velocity gas is made to flow through some sort of nozzle leaving the engine and causing it be thrust in the opposite direction. Recent work at NASA's Jet Propulsion Laboratory has focused on plasma driven rockets. It has been discovered that a rocket engine using a plasma as the stream of gas will generate more thrust with far greater efficiency than in other types of rockets engines. As described herein, the present invention is adaptable for use in this plasma type rocket engine.

Regardless of the type of engine, to generate power, some sort of fuel is necessary and some sort of reaction must take place. In internal combustion engines, a spark that ignites fuel that has been mixed with oxygen is used to start the reaction. Power in excess of that put in will come out of the reaction, the excess coming from the reaction, be it electrochemical, combustion, or electromagnetic. Local heating by carbon nanotubes exposed to EM radiation can be used for driving mechanical motion such as occurs in internal combustion or steam engines, turbines and other devices with mechanically moving parts whose operation depends upon local heating and thermal gradients.

Further, an embodiment of the present invention includes the use of carbon nanotubes in connection with EM fields to create a fuel cell based on electromagnetic ionization of hydrogen thereby removing the hydrogen from its storage matrix and ionizing it in one step. This could be used to increase the efficiency of hydrogen fuel cells. Other inert gases other than hydrogen can also be used for this effect and are included within the scope of the present inventions. Such devices serve as rapid delivery devices for ionized fuel. These ionized atoms could be separated through a membrane into positive and negatively charged particles which could be made to generate a potential or voltage which could be used by electrical devices. The devices of this embodiment of the present invention can be scaled down to the nanoscale at which carbon nanotubes exist or higher for such devices as plasma-driven engines or power production plants.

This process of the present invention can be adapted to rapidly heat whatever structure with which the carbon nanotubes are blended. The carbon nanotubes will be selectively superheated and radiate heat into the matrix in which they are blended, which will in turn cause a rapid increase in temperature in the storage matrix.

When carbon nanotubes are heated, first any gases that are present will separate. However if the carbon nanotubes are caused to superheat, a plasma will be formed when the gas is stripped of its electron. The characteristic of the present invention can be used in a variety of applications, including but not limited to, fuel cell applications and plasma applications. Fuel cells do not require the plasma to be lighted, just that it is possible to remove the electron from the proton. This embodiment of the present invention could then be used to pass the proton through a membrane and make use of the electrical charge on the electron in the same fashion as in a fuel cell, advantageously, without the need for several of the pieces normally required in a fuel cell. The hydrogen can be extracted and the hydrogen ionized all in the same step improving the efficiency of energy production The reaction can be controlled in a variety of methods depending on the total heat production, efficiency, and overall reaction speed desired.

In medical applications, the present invention allows the delivery of remotely controlled light and heat instantaneously to regions within the human or an animal body where carbon nanotubes can be placed. This will permit precise methods for microsurgery and microtherapy. For example, cancerous tissues and cells can be selectively removed by use of external electromagnetic fields that activate intense radiation from the carbon nanotubes but otherwise are otherwise harmless to the body. The carbon nanotubes can be placed within the body by a variety of means, for example, by chemically attaching to nanoscale objects such a nanoparticles, that move readily through the body and have specific tags which cause attachment to the target cancer cells.

The present invention can be adapted to cause a desired reaction under water. Such a reaction would be useful in delivery of immediate intense heat sources in this environment for such things as repair of micro-holes in the hulls of ocean going vessels. A hand held embodiment of the present invention could be fabricate to perform this task.

The light emitted from carbon nanotubes irradiated by EM waves as described herein exhibit a range of wavelengths or energies ranging from the soft X-ray region through the ultraviolet into the visible and extending into the infrared regions. The peak intensity of this light, typically in the visible region, can be moved to higher or lower wavelengths by using carbon nanotubes of different diameters and/or changing the materials or impurities that are trapped within the interior of the carbon nanotubes. Using these methods alone or in combination, the spectral characteristics of the light delivered from the carbon nanotubes to specific locations, as required by the specific application, can be altered as desired for the purposes of enhancing the specific application.

Further, depending on the parameters of amount and type of carbon nanotubes and the frequency and power of the EM radiation, carbon nanotubes can heat the local regions surrounding them to temperatures of at least 2000 K. which can, for example, melt silicon dioxide, a typical component of glass. The production of these high temperatures can be used as a light replacement as the causal agent for the effect by heat and temperature rise. The production of heat to local areas can be used to instantaneously induce local chemical and physical processes such as degradation, initiation of explosions, melting, vaporization, and boiling, among other things.

In order to vary the heat or control the other effects of the reactions, a variety of parameters can be varied. One such parameter is the total volume of sample involved in the reaction. The volume can vary from microscopic range for small battery or chip power production up as large as that useful for power plant energy production. In order to control the reaction one may also alter the power level delivered to the sample at a particular microwave frequency. The controllability of microwave sources permit small changes in the amount of microwave power delivered in experimental data runs. The small power changes have exponential differences in the amount of heat production or efficiency of the power production. Advantageously, this applications may be implemented in size or scale from the microscopic power requirement range all the way to the macroscopic range.

Another way to control the reaction process is by exposing the carbon nanotubes to various frequencies of microwaves and in different resonant conditions. Different frequencies in the microwave range are absorbed by carbon nanotubes with different efficiencies. By changing the frequency, the overall efficiency, size and speed of the reaction can be controlled.

Resonant Conditions

Many theoretical and experimental achievements have been made in resonant conditions of electromagnetic waves. This conditions allow accurate separation of the electric and magnetic field as well as amplification of the electric or magnetic fields. In the far field configuration the E-fields reach maximums at several 100 s Volts per cm. In the resonant cavity conditions results as high as 1.2 million Volts per cm have been reported. These increased E-fields are where the effects, such as light intensity and heat obtained by the present invention are at a maximum.

Near Field Configuration

In the near field configuration with the source to sample distance very low E-fields are also at a maximum. This is due to the two fields (E and B) not being fully coupled at this point in the wave thus causing the E-field to go to 10 s of thousands of volts per cm without the need of a cavity or other resonant condition such as resonant waveguide.

FIG. 8 is a schematic illustration of a generalized apparatus 800 any other implementation which can be configured to utilize the effects of electromagnetic irradiation of carbon nanotubes. The present invention uses any general configuration in which any microwave, or, in general, electromagnetic radiation emitting source 801, is placed at any convenient distance from the carbon nanotubes 802 contained in any generalized containment matrix or structure 803, that allows the E-field 804 to reach the carbon nanotubes 802. The output 805 can include any form of released energy, including but not limited to light, heat and charged particles, that can be further harnessed by any desired and appropriate means.

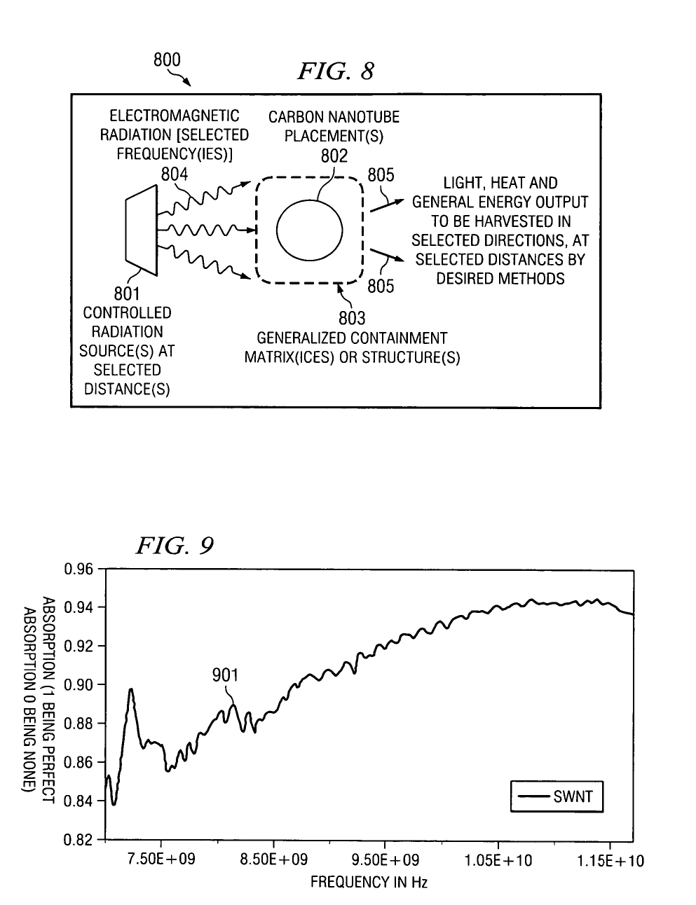

FIG. 9 shows the microwave absorption spectra 901 of narrow diameter nanotubes (1.1 nm diameter average) sample. The frequency range of 7 to 12 GHz is one the most efficient frequency range to work in for purposes of implementing the invention.

SWNTs used in one embodiment of the present invention were produced via the HiPco (High Partial Pressure of CO) process. HiPco refers to a process of growing SWNTs using high pressure carbon monoxide in a vapor disproportionation process. In order to be of any practical or commercial use, nanotubes must be produced with high levels of purity in large quantities. The HiPco process has shown some promise of being scaled up for large scale production and can also produce nanotubes that are >90% pure. In this synthesis process, a reaction of Fe(CO)₅ and CO gas at high pressure and high temperature takes place. When the metal catalyst atoms form larger clumps of material, approximately the size of the C₆₀ molecule, they nucleate and form SWNTs. This occurs because a SWNT is a more stable form of carbon than what is in the chamber at this point in the process. Due to this, the carbon will preferentially take on the SWNT form. The average diameter of HiPco nanotubes is 1.1 nm and their lengths can be microns long. These HiPco SWNTs display strong microwave absorption characteristics, e.g., 1.01×10⁻⁵ eV microwave field, with subsequent light emission, intense heat release, out-gassing, mechanical extension and nanotube reconstruction. SWNTs produced via other processes can also be used in the process and apparatus of the present invention.

In air and under application of the microwave field, SWNTs ignite and burn. The regions of the SWNTs that undergo this process show a partial permanent color change from black to orange. These orange regions fluoresce under normal room light. A TEM image of these orange regions shows a change to amorphous carbon structures that are 50-500 nm in diameter with no discernable tube structure. The purified nanotubes, when in the presence of the microwave field in air, only display random scintillation of white light.

A novel reaction occurs when either purified or raw SWNTs are exposed to EM under conditions of vacuum of approximately between 10⁻⁴ torr and 10⁻⁸ torr pursuant to one embodiment of the present invention. Depending on the embodiment, the microwave frequency can be between 0.1 GHz and 100 GHz, including in one embodiment about 2.45 GHz, and the EM power between 0.1 Watt and 1,500 Watts or where the EM field incident on the carbon nanotubes is about 1.01×10⁻⁵ eV. Carbon nanotubes in the vacuum system caused higher levels of vacuum (lower pressures) to be reached than normally observed, possibly due to molecular gas adsorption by the carbon nanotubes. Both the raw and purified carbon nanotubes, when placed under vacuum in the presence of the EM field, emit white light. The process is repeatable with no observable degradation of the light intensity over approximately 20 seconds of microwave irradiation. After minutes of constant exposure, there is a diminution of light, though the carbon nanotubes are still light-emitting. If lower wattage microwaves are used, for example less than 100 Watts, the nanotubes can become sufficiently hot to outgas adsorbed or absorbed gases, however tube reconstruction is less, if at all. FIG. 9 is a plot 900 of the residual gas analysis (“RGA”) of outgassed atomic masses from pure HiPco nanotubes during microwave field application. The spike at located at atomic mass unit 2 represents hydrogen in molecular form. This chart is in a log scale and the quantity of hydrogen removed is approximately 100 times more than any other atomic mass. Short exposure pulses of approximately 3 to 5 seconds can be repeated with no obvious degradation over the 35 pulses attempted.

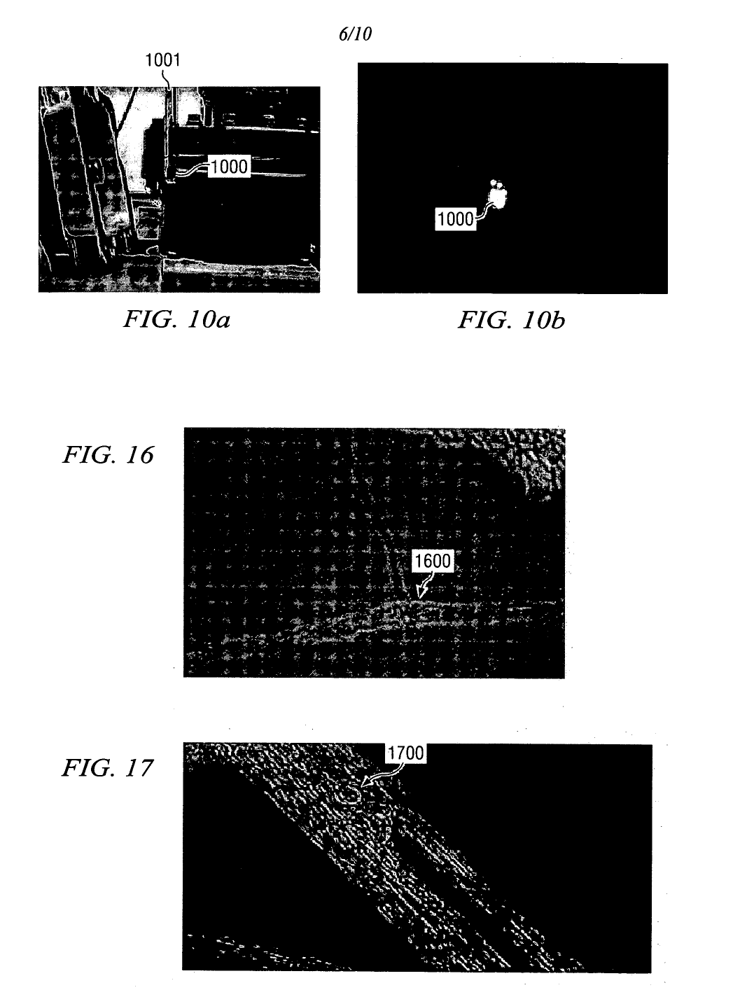

FIG. 10(a) illustrates SWNTs 1000 in an ultra high vacuum tube 1001 suspended above the microwave source wherein the tube is shown containing SWNTs under vacuum with room lights on. FIG. 10(a) shows a sample of HiPco nanotubes as a microwave field is applied. FIG. 10(b) illustrates SWNTs 1000 in an ultra high vacuum tube 1001 suspended above the microwave source wherein the tube is shown containing SWNTs under vacuum during microwave irradiation at a frequency of 2.45 GHz and 700 Watts of power with the room lights off.

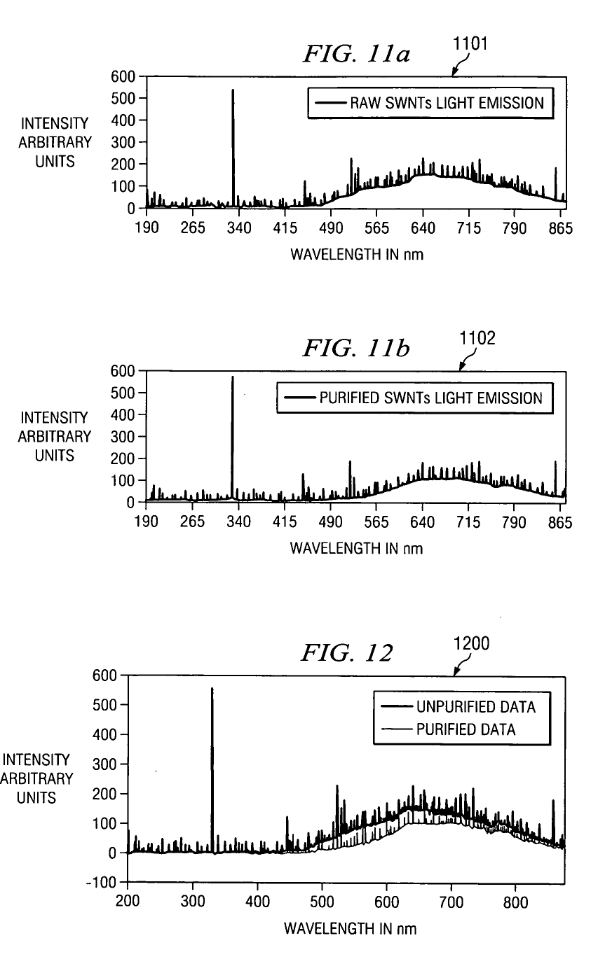

Light emissions from carbon nanostructures have been previously observed in C₆₀. The light in the current experiment is very broadband with peaks superimposed on the broadband emission spectrum. These emissions extend from the ultraviolet (“UV”) range, through visible and into the infrared (“IR”) regions of the electromagnetic spectrum. As seen in plots 1101 and 1102 of FIGS. 11(a) and 11(b), the majority of the broadband emissions are in the visible and near infrared (“NIR”) regions and the UV components consist mainly of spikes that correspond to carbon, iron (the catalyst in HiPco synthesis), carbon monoxide (the carbon source in HiPco synthesis) and hydrogen. Some of these species may be pyrozylates that are formed through the thermolysis of adsorbed organics such as pump oil which is present, in small quantities, in UHV.

The light emission under vacuum conditions is accompanied by outgassing in both the raw and purified carbon nanotubes. The expelled gas is what was previously adsorbed by the carbon nanotubes and consists primarily of hydrogen, as observed using a residual gas analyzer (“RGA”). The described embodiment of the present invention shows microwave fields to be an efficient method for extracting hydrogen from carbon nanotubes. The emission of light from the carbon nanotubes continues after the hydrogen is desorbed.

In addition to the light emission and outgassing, the microwave irradiation of the samples in the described embodiment of the present invention is accompanied by a very rapid temperature increase in the samples. In one embodiment, the temperature reached as high as 2000° C., as measured by a pyrometer, when using 2.45 GHz, 700 W magnetron, which is to be expected with this type of broadband emission.

The heat release, light emission and gas evolution were further accompanied by the carbon nanotube samples undergoing intense mechanical motion. When irradiated with the microwaves as described herein, the initial fluffy material spreads to about twice its original volume, and when the microwave field is turned off, the material contracts back to its near-original size. This occurs in a repeatable manner upon the short exposure cycles even after the majority of the outgassing has occurred. This implies a wide spectrum of phonons being created. The build up of the phonon spectrum in this case is consistent with the visually recorded delay of approximately 1 second for light emission to occur. This may induce electron plasma, which can emit frequencies up to the soft x-ray region, fitting with previous simple models. Repeated exposures to the microwave radiation causes a decrease in the observed mechanical motion, most likely a result of crosslinking or welding of the tubes.

FIG. 12 is a plot 1200 of the spectra of light from both purified and unpurified HiPco nanotubes as microwave field is applied. The wavelength is in nanometers and the intensity is in arbitrary units. It should be noticed that most of the peaks are in the same locations on both samples, merely showing different intensities.

One embodiment of the present invention utilizes a microwave source comprising a 700 watt magnetron at 2.45 GHz located proximate to the SWNTs, such that microwave radiation is incident upon the SWNT. Other microwave sources at different power and frequency settings can also be utilized. SWNTs were tested in both the purified and raw conditions. It is often necessary to generate a microwave signal. The generation of low frequency EM signals is usually achieved via the transfer of electrical energy from a steady electric field into an alternating field. In this situation, a signal with the desired frequency is always present. This is typically due to thermal noise. The desired frequency is then selectively amplified to the desired power level by feedback with the phase relation that is appropriate to the application. This technique works reasonably well for frequencies up to approximately 1 GHz.

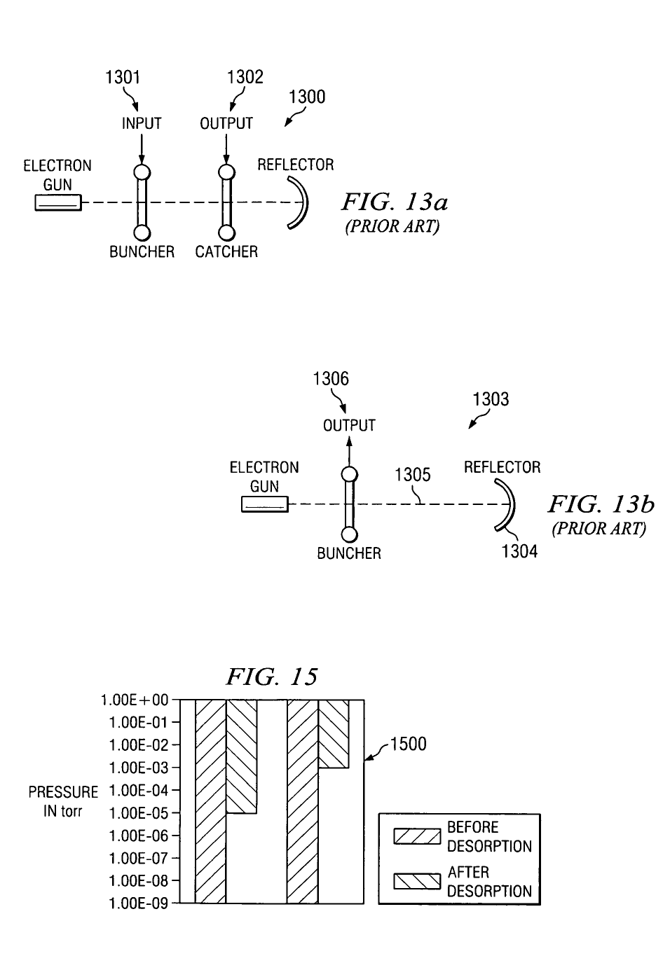

At frequencies of 1 GHz to 10 GHz a different technique is necessary. At these higher frequencies the finite transit times of electrons will have a degrading effect on such things as the oscillator circuit, rendering signal sources very poor without a change of the generation technique. As seen in FIG. 13(a), a specially designed dual cavity klystron 1300 with planar triodes is typically employed for signal sources in these ranges. The electron transit time has no effect on these devices due to their geometry. These devices consist of small distances between the triodes and a high accelerating voltage. These triodes are used in conjunction with a tunable dual-resonant cavity. These devices can typically be retuned to a significant portion of the 1 to 10 GHz portion of the microwave spectrum, and the maximum power output from such a device is in the range of 10 Watts.

As seen therein, these dual cavity klystrons 1300 consist of two resonant cavities 1301, 1302 in tandem through which passes an electron beam. A radio frequency (“RF”) field, in the first cavity 1301 will bunch the electrons into groups. These groups then pass into the second cavity 1302 and induce an RF field. In other words, the first of the two cavities slightly accelerates some electrons, while others are slowed down. The acceleration and deceleration is determined by which portion of the RF cycle the electrons are in. After several millimeters of transit, the faster electrons will catch the slower ones and the maximum allowable “bunching” will occur. It is at exactly this position that the second of the two resonant cavities is situated. Further along the beam line the accelerated electrons have passed the slower ones and the electrons are again debunched.

If in some portion of the RF cycle energy from the second resonant cavity is fed back to the first resonator in the correct phase, the klystron will become an oscillator. The frequency of oscillation is determined by the resonant frequencies of the cavities (which can be adjusted by changing their physical size). The accelerator voltage may cause a small change in the oscillation frequency.

Where the dual cavity klystron leaves off in frequency, the reflex klystron will take over. A reflex klystron, while capable of emitting higher frequencies, is typically not capable of emitting signals with power levels higher than 1 Watt. This power level, while not useful for most commercial applications, is highly useful in the spectroscopy laboratory, provided the signal is very “clean”. These clean signals are signals with very little drift in center frequency or statistical noise. A reflex klystron offers this type of signal and for this reason, historically, have been the signal source of choice for microwave spectroscopists. As seen in FIG. 13(b), reflex klystron 1303 is simplified over the dual cavity version by removal of one of the two cavities. Due to this simplification, it is necessary to add a reflector electrode 1304 that is negatively charged. This electrode will reflect the electron beam 1305, just as a mirror reflects visible light. After the beam is reflected it will re-enter the cavity 1306 delivering more energy than originally received by the cavity 1306, provided that the reflector 1304 to cavity distance is properly tuned and the “repeller” voltage is properly set.

Backward wave oscillators (“BWO”) are another good microwave signal source. In a BWO, the electron beam is compressed with the application of a static magnetic field along the longitudinal axis. These sources are very useful as sweep signal generators due to their ability to be tuned over a fairly wide range of frequencies. This sweeping is not done by mechanical means but rather by varying the electron beam voltage.

For some applications, a much higher power level is required from a microwave source. These applications typically employ a magnetron. In a magnetron source, a static magnetic field is applied perpendicularly to the electron beam. This is to force the electrons into a nearly circular path. This will extend the amount of interaction time and allow a much higher power level to be achieved.

In an effort to remove the need for high beam voltages, new semiconductor devices for microwave measurements have been utilized. Strip line techniques are employed to reduce the physical size of the circuits. These sources are quite versatile, offering excellent frequency stability, on the order of one part in 10⁹, over a wide range of frequencies. These sources are typically very low power, on the order of 100 mW.

The most basic way of detecting any kind of microwave signal is by demodulating the signal, and using a semiconducting diode. These diodes are very mature technology and relatively immune to ‘false’ readings, if used properly. While these devices are relatively error free, on occasion more sensitive detection methods are needed. Increased levels of sensitivity are found in superheterodyne receivers. The signal frequency detected (f) is combined with the frequency of a local oscillator (fLO), and this combination yields an intermediate frequency (IF):
f_{IF}=|f−f_{LO}| (5)
with:
f_{IF}=Intermediate frequency
f=Frequency detected
f_{LO}=Frequency of the local oscillator

The local oscillator frequency must cause the IF to equal the frequency of an IF filter. The filter device allows the signal to be amplified over only a small bandwidth by amplifiers. By using this principle, the frequency of the detected signal is transformed to a lower frequency (between 10 MHz and 300 MHz typically). It is in this lower range that amplifiers produce far less noise. This type of receiver tends to have a much improved signal-to-noise ratio, making it superior to diodes by a factor as large as 10⁵.

To improve detection even further, twin channel superheterodyne receivers are employed. The second channel can be employed to lock the signal frequency by an automatic frequency control unit. This allows for signal sources which do not ‘drift’. Many newer systems will frequently use a network analyzer. In these systems a swept, or stepped frequency source, is locked into a superheterodyne receiver. Vector network analyzers use a dual channel receiver to measure ratios of amplitudes and the differences in phase for the two signals fed in. It is, therefore, capable of determining the real and imaginary parts of an unknown 2 port device. These analyzers typically come packaged with a computer to allow automated measurements, suitable processing of signals such as signal averaging and filtering of background noise. These types of computer controlled devices are intended to reduce errors. The system will attempt to remove what it determines to be systematic errors and display what it thinks is the correct measurement, based on a statistical analysis algorithm, which in many cases tends to remove important details.

In frequency ranges lower than the microwave region, for instance the 60 Hz signal typical of household wiring, lines can be treated as connections with ohmic resistance between elements. In the microwave range other phenomenon must be given consideration. Reactive impedances become important and their importance increases dramatically with frequency. The reactive impedance of a transmission line will be highly dependent on its geometry, shape, and size, thereby making these three things non-trivial in nature. Two wire lines do not work very well for these microwave applications, as the signal in one wire can and may have adverse affects on the other wire due to overlapping EMF fields. The attenuation between two wires will decrease with the distance between them. This makes wire placement and isolation in any piece of microwave equipment an important decision. Waveguides are, therefore, a more favorable technique for transporting a signal from one place to another.

Waveguides are basically hollow pipes and are available in many different geometries. Most common are the rectangular and circular waveguides. There are two types of field configurations inside waveguides. The first has the electric field component in the direction of the wave propagation (TM-modes) and the second has the magnetic field in the direction of wave propagation (TE-modes). For certain configurations, which are dependent on the frequency range used, various physical sizes of waveguides are necessary. This change in size is due to the changes in wavelength associated with the shift in the frequency being examined. Waveguides also do not suffer from the sometimes an enormous amount of signal degradation and loss that can occur in wires making them a far superior method of signal transmission.

Microwaves and Nanotubes

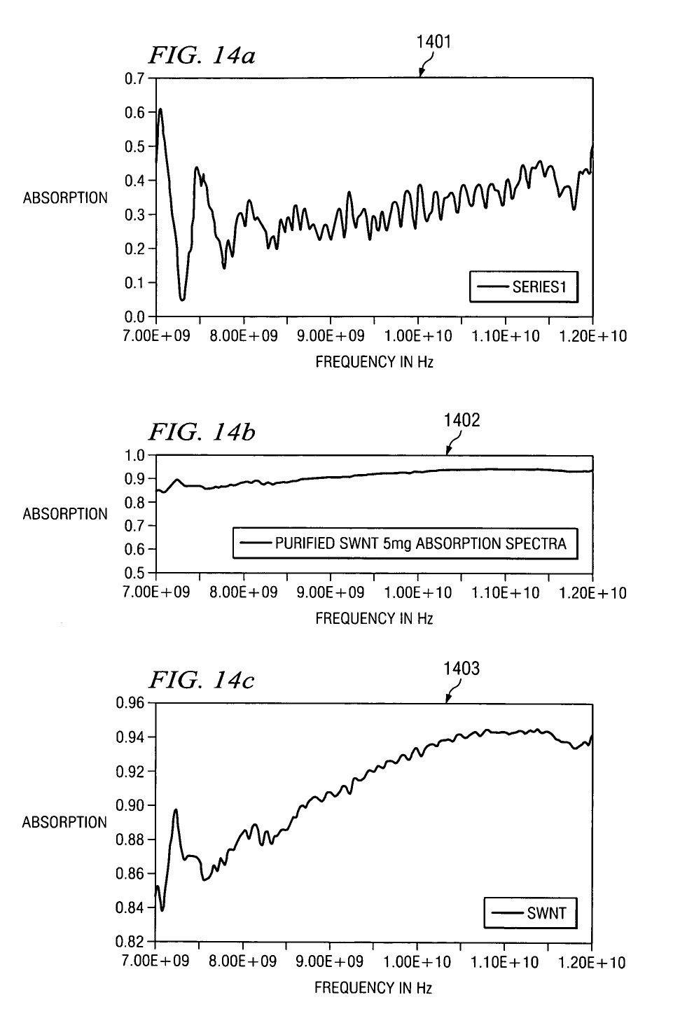

Buckypaper is a thin membrane of purified SWNTs. There is generally no alignment of the tubes in buckypaper and the thickness of the membrane depends on the sample preparation protocol, but it is generally 1-100 microns thick. In FIG. 14(a), absorption spectra of buckypaper over the range of 7 to 12 GHz can be seen. This spectrum was taken with a sweep source and consists of 25 sweeps across the entire range. The results shown are the average of these sweeps to remove experimental error sources. The signals recorded are the transmitted and reflected power levels, which were then added together, and subtracted from the reference voltage. The original reference voltage was then divided into this voltage in order to obtain the “percent” of the microwave signal absorbed by the bucky paper. Carbon nanotubes are known to be efficient microwave absorbers. Normally, long chain molecules absorb over a wide range of frequencies. A group of nanotubes, such as that found in buckypaper, is essentially a large group of very long-chain molecules. These molecules will have different length distributions and the microwaves and nanotubes interact in different ways based on the distribution of lengths. In FIG. 14(b) and 14(c), an absorption spectrum in the range of 7 to 12 GHz of 5 mg of purified SWNTs can be seen. This shows a larger absorption, which is to be expected, with the increased number of long chain molecules in the sample. These broad-extended, range interactions are not only unusual but, appear to be very useful.

A Mechanism for Interaction

Not intending to be bound by any suggestion of mechanism, the interaction of the nanotubes with microwaves is complex, with possibly several mechanisms at work, however, one known interaction could be found from previous long chain molecule research. The valence electrons in long chain, or any nonlinear molecules, do not move in a cylindrically symmetric field. For this reason, no component of their orbital angular momentum can be found to be constant. The electron orbital momentum must be considered as a portion of the rotational momentum of the entire molecule (if it is assumed that the interaction is for only one molecule at a time). The interaction of the electron spin (L) and orbit (S) of the type AL S is only possible when there is a slight uncoupling of L from the rotation of the molecule. Where A: is the largest rotational constant of an asymmetric rotor. L: Electronic angular momentum of an entire atom or molecule, S: Electron Spin Angular Momentum. Another mechanism might involve a microwave interaction with iron nanoparticles that occupy the end of the nanotubes. Upon irradiation with microwaves, the iron nanoparticles efficiently absorbs the microwave and transmits the energy to the nanotube to which it is coupled. A third mechanism could involve an excitation of nanotube electrons from one or more of the tube types (i.e., the semi metallic tubes) into an electron plasma that coats the tube surface. This would account for the light emission and the apparent material expansion during the irradiation cycles.

High Power Interaction

For the spectra 1401, 1402 and 1403 shown in FIGS. 14(a), 14(b) and 14(c) respectively, the microwave sources are very low power sources, which is typical when performing spectroscopic measurements. In order to be of commercial interest in many cases, nanotubes must be able to interact efficiently with high power microwave signals. The present invention can be implemented at 2.45 GHz with 750 Wats of power. When the microwave field emitted from the source described above irradiated SWNTs in their raw, unpurified state in air they ignited and burned within three seconds and powder X-ray diffraction indicated the presence of hematite as an orange residue.

The ignition of the raw nanotube sample was due to a combination of factors. The presence of large amounts of carbonaceous materials, a typical impurity, on the nanotube ropes appears to retard the radiation of heat caused by the microwave absorption. The other factor is that the microwave field will cause the nanotubes to outgas hydrogen. When the hydrogen interacts with several hundred to several thousand degrees centigrade temperatures that the sample appear to reach within the first three to five seconds, an “ignition” in air is to be expected.

When the purified and raw nanotubes are placed in UHV conditions (1×10⁻⁹ torr) another novel phenomenon is seen. Having the nanotubes in the vacuum system allows for a lower level of vacuum to be reached than possible when the nanotubes are not present. The nanotube ropes will adsorb a large amount of hydrogen, which is typically what prevents a UHV system from achieving lower pressure levels, and in this case allowed an order of magnitude drop in pressure in the system with nanotubes compared with the same system without a nanotube sample in place.

Raw and purified nanotubes in UHV under the application of the same microwave field discussed above both emit bright white light. The spectrum of this white light is broadband. Many of the ‘spikes’ on the spectrum that appear at first glance to be signal to noise problems. There are in fact identical in the purified and raw nanotube spectra. It is suggested that these peaks are atomic emission lines belonging to either H, C, CO, or Fe, which constitutes every element present in the sample. SWNT emissions extend slightly further into the UV than those from a sample of purified nanotubes with similar mass. A Geiger counter was placed near the apparatus to test for any high energy emissions beyond UV. Radiation levels slightly higher than the normal background were observed from purified SWNTs where average diameters near 1 nm. This radiation may indicate emissions in the soft x-ray region. The temperatures of both physical and raw SWNTs of the system were observed using a pyrometer that measures blackbody radiation at 2 μm. These observed temperatures were in the range of 2000° C.

In a hydrogen free system, there are several mechanisms that account for the emission of optical, ultraviolet and soft X-rays. SWNTs are mechanically extremely supple, with a wide range of motions possible without destroying the integrity of the nanotubes. Under exposure to a microwave source the nanotubes are found to undergo severe mechanical motion, co-temporal with thermal heating. This implies that a broad spectrum of phonons is being created in the sample and possibly an electron plasma. This is due to the nanotubes having high Q and the presence of defects and contorted geometry. The build-up of the phonon spectrum, since its origin is the dynamical motion of nanotubes, will take seconds. This time scale corresponds to the delay seen before visible radiation occurs.

At some point, the phonon frequency will match the absorption frequency of the outer electrons in the nanotube structure, and they will be ionized, although not intending to be bound by any particular mechanism. This process forms an electron plasma which exchanges energy with the phonon sea. Once the electron plasma reaches the plasma edge, it will radiate in the optical, UV and soft X-ray regions, absorbing and reradiating most of the incident energy in a steady state equilibrium. The entire sample seems to radiate as a single object, due to electron coupling among the nanotubes, which form a “giant dipole resonator.” This system can both absorb and emit electromagnetic energy very efficiently.

SWNTs that have a diameter of one nanometer make them quantum waveguides that delocalize electrons in their interior, adding to the effect by increasing the effective collision cross section. A single nanotube, which is immersed in such a dense spectrum of phonon states, can be considered as a single extended quasi-particle. To a first approximation, it can be thought of as a physical realization of a one-dimensional quantum string. The coupling among nanotubes is so strong, due to phonon and electron exchange, that the material has collective dynamics. Visual reactions to the application of the microwaves to the HiPco SWNTs took place approximately 1 second after application of the microwave field. Laser-oven-generated SWNTs were also utilized. The reactions from this type of SWNT were not easily observable, due, perhaps, to the increased average diameters in these types of SWNTs vs. the HiPco SWNTs or differing amounts of iron remaining in the sample.

Mechanisms of Hydrogen Storage in Carbon Nanotubes

Another aspect of the present invention comprises a process and apparatus for filling of the inner capillary of nanotubes with hydrogen. As noted, if a beam of hydrogen atoms were incident on the walls of the nanotubes with energy levels of approximately 20 eV they will rip through the wall and enter the nanotube. The defects caused in nanotubes on the scale of which would be caused by the channeling will self-repair in approximately 1 picosecond. An accelerator was used to implement the ion beam line process. The energy of an accelerated beam of hydrogen. To implement the channeling process, a 4 mg sample was run in the ion beam line with the incident energy of hydrogen impact the carbon nanotubes of 5 keV. The hydrogen slows down as it passes through more and more nanotubes until it is finally captured the implantation. The particle rate was approximately 1 particle every 10⁻⁹ seconds which is slow enough to allow the self-repairing of the nanotubes. The sample was placed in the apparatus in such a way to measure not only the total charge incident on the sample but also what charge channeled through. This allowed the total number of trapped particles to be determined to be approximately 10¹⁷ hydrogen atoms.

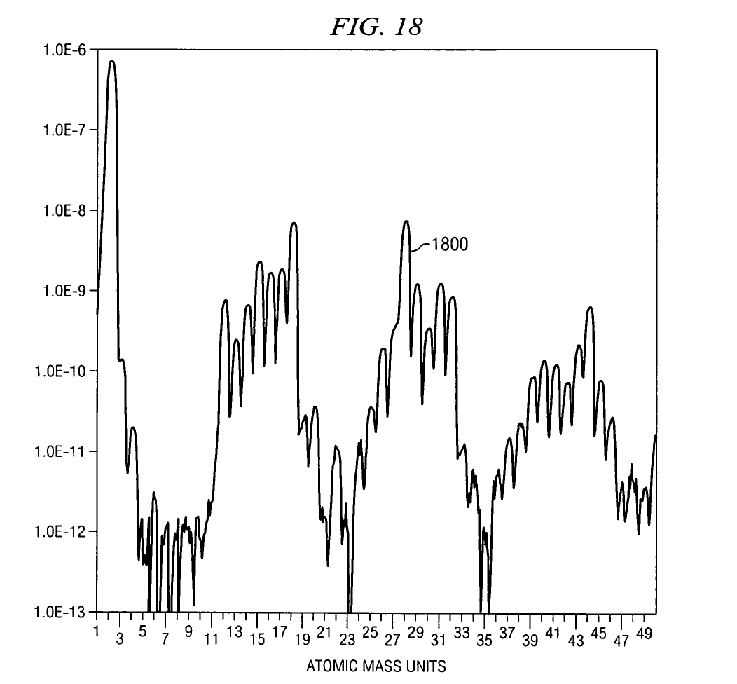

Once these samples were prepared, desorption of two almost identical nanotube samples was conducted. A first sample consisted of 4 mg of SWNTs which had not been implanted with hydrogen via the beam line implantation method, but were bathed in an environment of approximately 100 torr of hydrogen for 1 hour. A second sample was also bathed in an environment of 100 torr of hydrogen for 1 hour and then implanted with approximately 101⁷ hydrogen atoms. As seen in FIG. 15, the results 1500 of the subsequent desorption experiment show a large increase in the amount of stored hydrogen. For the first sample it was found that the levels of hydrogen in the vacuum system rose from about 10⁻⁹ torr to about 10⁻⁵ torr. For the second sample in the same vacuum system, RGA analysis showed a level of about 10⁻⁹ torr of hydrogen previous to desorption and complete saturation of the instrumentation on the hydrogen channel following desorption. As the RGA does not saturate until 10⁻³ torr, this indicates a large increase in the amount of hydrogen removed from the sample indicating that the implantation was possible. FIG. 18 is an RGA plot 1800 of outgassed materials from carbon nanotubes during microwave application.

Carbon Nanotubes After Irradiation

Another aspect of the present invention is as an effective means of welding nanotubes or nanotube-based ropes in their pure states or after dispersion in blends or composites, thereby altering the mechanical properties of the final materials. TEM imaging of the carbon nanotubes after microwave irradiation in UHV showed that many of the nanotubes fused or welded into neighboring tubes to form junctions. The well-defined junction formations 1600 can be seen in FIG. 16. Additionally, as seen in FIG. 17, looped structures 1700 formed and are abundant in the irradiated tubes. The welding of SWNTs requires breaking of carbon bonds and rearrangement of the carbon atoms. In order for this to take place, temperatures must reach at least 1500° C., indicative of an efficient absorption of microwaves. It is well known that frequency up-conversion occurs in these regions in pyroelectric crystals. A similar mechanism may be at work in the SWNTs. Thus, the process and apparatus of the present invention described herein is an effective means of welding nanotubes or nanotube-based ropes in their pure states or after dispersion in blends or composites, thereby altering the mechanical properties of the final materials.

Summary of Inventive Aspects

The innovative teachings of the present invention are described with particular reference to the process of exposing carbon nanotubes to EM radiation and apparatus that implement same, and the applications derived therefrom. Furthermore, a few embodiments of undertaking the novel process is described herein. It should be understood and appreciated by those skilled in the art that the arrangements, uses, and embodiments described herein provide only a few examples of the many advantageous uses and innovative teachings herein. For example, different vacuum pressures and microwave power settings and frequencies can be used to obtain the same novel results, such as light emission, and heating. Various alterations, modifications and substitutions can be made to the process of the disclosed invention and the apparatus' that implement the present invention without departing in any way from the spirit and scope of the invention.

1. An apparatus for generating localized heat and light, comprising
an EM radiation source with a desired power setting and frequency;
a source of at least one nanostructure located proximate to said EM radiation source; and
a means of exposing said nanostructure to the EM radiation source for a predetermined duration.

2. The apparatus of claim 1, wherein the nanostructure comprises a nanotube.

3. The apparatus of claim 1, wherein the predetermined duration is between 10 milliseconds and 10 seconds.

4. The apparatus of claim 1, wherein the nanostructure is a carbon nanotube.

5. The apparatus of claim 4 wherein the carbon nanotubes deliver controlled amounts of heat energy and light energy from low levels to very intense levels to microscopic locations in a remote object.

6. The apparatus of claim 4 wherein the carbon nanotubes deliver controlled amounts of heat energy and light energy from low levels to very intense levels to macroscopic locations in a remote object.

7. The apparatus of claim 4 wherein the E-field of the EM source incident upon the carbon nanotubes is at a maximum.

8. The apparatus of claim 7, wherein the carbon nanotubes are in a near field configuration.

9. The apparatus of claim 7, wherein the carbon nanotubes are in a resonant cavity or resonant conditions.

10. The apparatus of claim 4, wherein the carbon nanotubes are located in an oxygen-free environment.

11. The apparatus of claim 4 wherein the EM radiation is in between the radio and x-ray regions.

12. The apparatus of claim 11 wherein carbon nanotubes of different diameters are used to adjust the peak intensity of the emitted light wavelengths.

13. The apparatus of claim 11 wherein carbon nanotubes containing materials or impurities trapped within the interior thereof are used to adjust the peak intensity of the emitted light wavelengths.

14. The apparatus of claim 11 wherein the EM radiation is between 2 GHz and 90 GHz.

15. The apparatus of claim 11 wherein the EM radiation is between 2.4 GHz and 12 GHz.

16. The apparatus of claim 11 wherein the use of different frequencies of the EM radiation are operable to adjust the intensity of the emitted light wavelengths and heat emission.

17. The apparatus of claim 4 wherein there is an dielectric constant approximately equal to air between the EM radiation source and the carbon nanotubes.

18. The apparatus of claim 4 wherein the power setting of the EM source is between 30 Watts and 1000 Kilowatts.

19. The apparatus of claim 4 wherein the power setting of the EM source is between 3 Watts and 1 kilowatt.

20. The apparatus of claim 4 wherein the distance from the EM radiation source to the carbon nanotubes is between 0.0001 meters and 5 meters.

21. The apparatus of claim 4, wherein the carbon nanotubes are located within the local region of an object; and
application of EM irradiation to the carbon nanotubes releases stored energy therein to act upon said local region of an object in which the carbon nanotubes are distributed.

22. The apparatus of claim 4 wherein the release of energy from the carbon nanotubes is adapted as a localized energy production plant for an engine.

23. The apparatus of claim 22 wherein the release of energy from the carbon nanotubes are operable to increase the efficiency of an internal combustion engine.

24. The apparatus of claim 22 wherein the carbon nanotubes act as a catalyst for a rapid combustion reaction in said engine.

25. The apparatus of claim 4, wherein the carbon nanotubes are used as a catalyst or catalyst support in a catalytic system.

26. The apparatus of claim 4 for use as a catalyst in a rocket engine.

27. The apparatus of claim 26, for use in generating a plasma as the stream of gas in a plasma type rocket engine.

28. The apparatus of claim 4, adapted to remove and ionize hydrogen in one step from a storage matrix.

29. The apparatus of claim 28 for use in a fuel cell based on electromagnetic ionization of hydrogen.

30. These apparatus of claim 29 wherein ionized atoms are separated through a membrane into positive and negatively charged particles operable to generate a potential or voltage.

31. The apparatus of claim 4, wherein the carbon nanotubes are adapted to act as an emission source for charged particles, such as electrons or ions, when placed under electrical bias.

32. The apparatus of claim 4 wherein the carbon nanotubes are microscopic in size, operable to provide an intense microscopic heat source at a desired location.

33. The apparatus of claim 32, wherein the carbon nanotubes range from nanometer size to multiple grams, to kilograms.

34. The apparatus of claim 4 wherein the temperature at the location of the carbon nanotubes are controllable by adjusting the microwave power.

35. The apparatus of claim 4, wherein the carbon nanotubes comprise SWNTs.

36. The apparatus of claim 4, wherein the carbon nanotubes comprise purified SWNTs

37. The apparatus of claim 4, wherein the carbon nanotubes comprise raw SWNTs

38. The apparatus of claim 4, wherein the carbon nanotubes comprise MWNTs.

39. The apparatus of claim 4, adapted to provide a controlled bright light to a remote location.

40. The apparatus of claim 4 further comprising the blending of the carbon nanotubes into a matrix.

41. The apparatus of claim 40, wherein the blended carbon nanotubes are selectively superheated with applied EM radiation;
said superheated carbon nanotubes being operable to radiate heat into the matrix in which they are blended; and
said superheating being operable to cause a rapid increase in temperature in the storage matrix.

42. The apparatus of claim 4 operable to create plasmas at a remote location.

43. The apparatus of claim 4, operable to initiate chemical reactions or physical processes at a predetermined location.

44. The apparatus of claim 4, wherein at least one carbon nanotube is implanted in a human or animal body;
where said EM source is directed toward said implanted carbon nanotube; and
said resultant heat and energy release is operable to treat a disease or condition.

45. The apparatus of claim 44, for use in microsurgery or microtherapy.

46. The apparatus of claim 45, adapted to remove cancerous tissues and cells.

47. The apparatus of claim 44 wherein said carbon nanotubes are chemically attached to a nanoscale object such as a nanoparticle, adapted to move readily through the body; and
said nanoparticle being transported through the body.

48. The apparatus of claim 47, wherein the nanoparticles have specific tags which cause them to attach to targeted cells.

49. The apparatus of claim 4 adapted for use underwater.

50. The apparatus of claim 49, wherein the near-immediate generation of intense heat is adapted to repair micro-holes in the hulls of vessels.

51. An explosive device with a trigger, comprising:
an explosive charge admixed with dispersed carbon nanotubes;
an EM radiation source with a desired power setting and frequency;
a source of at least one nanotube located proximate to said EM radiation source; and
a means of exposing the nanotube to the EM radiation source for a predetermined duration.

52. The explosive device of claim 51, wherein the exposure of the carbon nanotubes to EM radiation generates intense heat and light in a highly uniform manner across the entire explosive charge; and
detonation events occur at microscopic distances in unison.

53. The explosive device of claim 51, the explosive charge further comprising a mixture of a highly oxidizable material, and a strong oxidizing agent.

54. The explosive device of claim 53, wherein the oxidizable material comprises a powdered aluminum metal.

55. The explosive device of claim 51 wherein the EM radiation in the microwave region.

56. The explosive device of claim 55 wherein microwaves are fired from substantially all sides of the material.

57. The explosive device of claim 51, further comprising the rapid production of gases operable to induce a local shockwave, further triggering adjacent explosive material.

58. An improved cathode, comprising:
a source of carbon nanotubes;
a vacuum operable to contain the source of carbon nanotubes;
an EM source located proximate the carbon nanotubes, operable to irradiate the source of carbon nanotubes; and
said carbon nanotubes operable to emit electrons to a positively charged electrode.

59. The cathode of claim 58, for use in visual displays.

60. The cathode of claim 58, further comprising impurities in the carbon nanotubes operable to create an electrical current.

61. The cathode of claim 60, wherein the impurity consists of hydrogen, oxygen or iron.

62. A process for generating localized heat and light, comprising
locating a source of nanotubes proximate to the location to be exposed to the heat and light;
locating an EM source with a desired power and frequency proximate to the nanotubes; and
exposing the nanotubes to the EM source for a predetermined duration.

63. The process of claim 62, wherein the predetermined duration is between 10 milliseconds and 10 seconds.

64. The process of claim 62, further comprising delivering controlled amounts of heat energy and light energy from low levels to very intense levels to microscopic locations in a remote object.

65. The process of claim 62, further comprising delivering controlled amounts of heat energy and light energy from low levels to very intense levels to macroscopic locations in a remote object.

66. The process of claim 62 wherein the nanotubes comprise carbon nanotubes.

67. The process of claim 66 further comprising configuring the carbon nanotubes such that the E-field of the EM source incident upon the nanotubes is as at a maximum.

68. The process of claim 67, further comprising configuring the nanotubes in a near field configuration.

69. The process of claim 67, wherein the nanotubes are configured in a resonant cavity.

70. The process of claim 66, further comprising locating the carbon nanotubes in an oxygen-free environment.

71. The process of claim 66, further comprising irradiating the carbon nanotubes with EM radiation between the radio and x-ray regions.

72. The process of claim 71, further comprising using carbon nanotubes of different diameters to adjust the peak intensity of the light wavelengths.

73. The process of claim 71, further comprising using carbon nanotubes containing materials or impurities trapped within the interior thereof to adjust the peak intensity of the light wavelengths.

74. The process of claim 66 further comprising irradiating the carbon nanotubes with EM radiation between 2 GHz and 90 GHz.

75. The process of claim 66, further comprising irradiating the carbon nanotubes with EM radiation between 2.4 GHz and 12 GHz.

76. The process of claim 66, further comprising irradiating the carbon nanotubes with EM radiation of different frequencies to adjust the intensity of the light wavelengths and heat emission.

77. The process of claim 66, further comprising irradiating the carbon nanotubes with EM radiation having power of between 30 Watts and 1000 Kilowatts.

78. The process of claim 66, further comprising irradiating the carbon nanotubes with EM radiation having power of between 3 Watts and 1 kilowatt.

79. The process of claim 66, further comprising locating the EM radiation source from the carbon nanotubes between 0.0001 meters and 5 meters.

80. The process of claim 66, further comprising:
locating the carbon nanotubes within a local region of an object;
applying the EM irradiation toward the carbon nanotubes; and
releasing stored energy therein to act upon said local region of an object in which the carbon nanotubes are distributed.

81. The process of claim 66, further comprising releasing energy from the carbon nanotubes to provide a localized energy production plant for an engine.

82. The process of claim 81, further comprising increasing the efficiency of an internal combustion engine.

83. The process of claim 82, further comprising using the carbon nanotubes as a catalyst for a rapid combustion reaction in said engine.

84. The process of claim 66, further comprising using the carbon nanotubes as a catalyst or catalyst support in a catalytic system.

85. The process of claim 66, further using the carbon nanotubes as a catalyst in a rocket engine.

86. The process of claim 85, further comprising generating a plasma as the stream of gas in a plasma type rocket engine.

87. The process of claim 66, further comprising removing and ionizing hydrogen or other materials from the carbon nanotubes from a storage matrix in one step.

88. The process of claim 87, further comprising using the storage matrix as a fuel cell based on electromagnetic ionization of hydrogen.

89. The process of claim 88, further comprising separating the ionized atoms through a membrane into positive and negatively charged particles operable to generate a potential or voltage.

90. The process of claim 89, further comprising adapting the cell to act as an emission source for charged particles, such as electrons or ions, when placed under electrical bias.

91. The process of claim 66, further comprising generating heat at a desired microscopic location by applying the EM source to a microscopic size carbon nanotube.

92. The process of claim 91, wherein the carbon nanotubes range from nanometer size to multiple grams to kilograms.

93. The process of claim 66, further comprising controlling the temperature at a desired location of the carbon nanotubes by adjusting the power of the EM source directed at such carbon nanotube.

94. The process of claim 66, wherein the carbon nanotubes comprise SWNTs.

95. The process of claim 66, wherein the carbon nanotubes comprise MWNTs.

96. The process of claim 66, wherein the carbon nanotubes comprise purified SWNTs.

97. The process of claim 66, wherein the carbon nanotubes comprise raw SWNTs.

98. The process of claim 66 further comprising blending the carbon nanotubes into a matrix.

99. The process of claim 98 wherein the blended carbon nanotubes are selectively superheated with applied EM radiation;
said superheated carbon nanotubes being operable to radiate heat into the matrix in which they are blended; and
said superheating being operable to cause a rapid increase in temperature in the storage matrix.

100. The process of claim 66, further comprising creating plasmas at a remote location.

101. The process of claim 66, further comprising initiating chemical reactions or physical processes at a predetermined location.

102. The process of claim 66, further comprising implanting the carbon nanotubes in a human or animal body;
directing said EM source toward said implanted carbon nanotube; and
using said resultant heat and energy release to treat a disease or condition.

103. The process of claim 102, operable for use in microsurgery or microtherapy.

104. The process of claim 103, operable to remove cancerous tissues and cells.

105. The process of claim 102, further comprising:
chemically attaching the carbon nanotubes to a nanoscale object such as a nanoparticle, adapted to move readily through the body; and
transporting said nanoparticle through the body to a desired location.

106. The process of claim 105, further comprising using a nanoparticle having a specific tag which causes it to attach to a targeted cell.

107. The process of claim 66, further comprising waterproofing said apparatus.

108. The process of claim 107, further comprising using the apparatus under water;
attaching or implanting carbon nanotubes at a microhole in a vessel or at an underwater pipeline;
applying EM radiation from the apparatus;
generating heat to repair defects in the hulls of vessels or underwater pipeline.

109. A process for generating charged particle plasmas, comprising:
placing a source of carbon nanotubes proximate within a container;
locating an microwave EM source with a desired power and frequency proximate to the carbon nanotubes; and
exposing the nanotubes to the microwave EM source for a duration of between 100 milliseconds and 5 seconds.

110. The process of claim 109, operable to provide an intense, localized heat and light source.
